(19) United States
(12) Patent Application Publication
(10) Pub. No.: US 2009/0068567 A1
(43) Pub. Date: Mar. 12, 2009

(54) ANODE FOR SECONDARY BATTERY, METHOD OF MANUFACTURING IT, AND SECONDARY BATTERY

(75) Inventors: Isamu KONISHIIKE, Fukushima (JP); Kenichi Kawase, Fukushima (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SONY CORPORATION, Tokyo (JP)

(21) Appl. No.: 12/103,328

(22) Filed: Apr. 15, 2008

(30) Foreign Application Priority Data
Sep. 12, 2007 (JP) 2007-236646

(51) Int. Cl. H01M 10/26; H01M 4/36; H01M 4/04; H01M 4/40

(52) U.S. Cl. 429/338; 429/218.1; 429/231.95; 427/58

(57) ABSTRACT

An anode for secondary battery is provided with an anode active material layer containing silicon on an anode current collector. Silicon in the anode active material has an amorphous structure. In a Raman spectrum of silicon having the amorphous structure after an initial charge and discharge, 0.25≦LA/TO and/or 45≦LO/TO is satisfied, where an intensity of a scattering peak occurred in the vicinity of shift position 480 cm⁻¹ based on scattering due to transverse optical phonon is TO, an intensity of a scattering peak occurred in the vicinity of shift position 300 cm⁻¹ based on scattering due to longitudinal acoustic phonon is LA, and an intensity of a scattering peak occurred in the vicinity of shift position 400 cm⁻¹ based on scattering due to longitudinal optical phonon is LO.

### CROSS REFERENCES TO RELATED APPLICATIONS

The present invention contains subject matter related to Japanese Patent Application JP 2007-236646 filed in the Japanese Patent Office on Sep. 12, 2007, the entire contents of which being incorporated herein by reference.

### BACKGROUND OF THE INVENTION

1. Field of the Invention

The present invention relates to an anode for secondary battery suitable for lithium ion secondary batteries and the like and a method of manufacturing it, more specifically to an anode for secondary battery that generates a small amount of irreversible capacity, a method of manufacturing it, and a secondary battery using it.

2. Description of the Related Art

In recent years, high performance and multifunction of mobile devices have been developed. Accordingly, for secondary batteries used as a power source for the mobile devices, it is demanded to reduce their size, weight, and thickness and to achieve their high capacity.

As a secondary battery capable of satisfying the foregoing demand, a lithium ion secondary battery is cited. The battery characteristics of the lithium ion secondary battery are largely changed according to the electrode active material used and the like. In the representative lithium ion secondary battery currently and practically used, lithium cobalt oxide is used as a cathode active material and graphite is used as an anode active material. The battery capacity of the lithium ion secondary battery structured as above is close to the theoretical capacity, and it is hard to largely increase the capacity by improvement in the future.

Thus, it has been considered to largely increase the capacity of the lithium ion secondary battery by using silicon, tin and the like that are alloyed with lithium when charged as an anode active material. However, in the case where silicon, tin and the like are used as an anode active material, the degree of expansion and shrinkage due to charge and discharge is large. Thus, the active material is pulverized by the expansion and shrinkage due to charge and discharge, or the active material is dropped from the anode current collector. In the result, there is a disadvantage that the charge and discharge cycle characteristics are lowered.

In the past, as an anode for the lithium ion secondary battery and the like, a coating type anode in which an anode current collector is coated with slurry containing a particulate active material and a binder has been used. Meanwhile, in recent years, an anode formed by layering an anode active material layer composed of silicon or the like on an anode current collector with the use of vapor-phase deposition method, liquid-phase deposition method, sintering method or the like has been proposed (for example, refer to Japanese Unexamined Patent Application Publication No. 8-50922, Japanese Patent No. 2948205, and Japanese Unexamined Patent Application Publication No. 11-135115). Thereby, the anode active material layer and the anode current collector are integrated. Thus, compared to the coating type anode, the active material is prevented from being broken into parts because of expansion and shrinkage due to charge and discharge, and the initial discharge capacity and the charge and discharge cycle characteristics are improved. In addition, it is possible to obtain effect that the electric conductivity in the anode is improved.

However, in the anode using silicon, tin and the like as an anode active material, in addition to the foregoing structural break disadvantage, there is a disadvantage that the irreversible capacity ratio to the charge capacity in a charge and discharge cycle is larger than that in the anode using graphite as an anode active material. That is, there is a disadvantage that the difference between the charge capacity and the discharge capacity therefrom obtained is large. Such a disadvantage may be caused by the following fact. That is, part of lithium ions extracted from the cathode and inserted into the anode when charged is retained in the anode for some reason, and is not able to be returned back to the cathode when discharged. In this case, an available amount of lithium ions is decreased. Thus, it becomes difficult to achieve a design maximally using the battery capacity. In the result, it is difficult to obtain sufficient charge and discharge cycle characteristics when the battery is actually used.

Therefore, to inhibit generation of irreversible capacity, in Japanese Unexamined Patent Application Publication No. 2001-210315 (p. 2) to be described, an electrode for lithium secondary battery containing an active material inserting and extracting lithium is proposed. In the electrode for lithium secondary battery, a microcrystalline silicon thin film or an amorphous silicon thin film that contains at least one impurity selected from the group consisting of phosphorus, oxygen, and nitrogen is used as the active material.

Japanese Unexamined Patent Application Publication No. 2001-210315 (p. 2) describes that the microcrystalline silicon thin film is a silicon thin film in which a scattering peak in the vicinity of 520 cm⁻¹ corresponding to the crystalline region and a scattering peak in the vicinity of 480 cm⁻¹ corresponding to the amorphous region are substantially detected in Raman spectroscopic analysis. Such a microcrystalline silicon thin film is different from a so-called polysilicon (multicrystalline silicon) in which only the scattering peak in the vicinity of 520 cm⁻¹ is detected, in the point that such a microcrystalline silicon thin film has the amorphous region. Further, Japanese Unexamined Patent Application Publication No. 2001-210315 (p. 2) describes that the amorphous silicon thin film means a silicon thin film in which the scattering peak in the vicinity of 520 cm⁻¹ corresponding to the crystalline region is not substantially detected and the scattering peak in the vicinity of 480 cm⁻¹ corresponding to the amorphous region is substantially detected in Raman spectroscopic analysis.

Further, in Japanese Unexamined Patent Application Publication No. 2001-291512 (pp. 3, 4, 7 and 8, and FIG. 1) to be described, the following nonaqueous electrolyte secondary battery is proposed. In the nonaqueous electrolyte secondary battery, the following material is used for an anode capable of inserting and extracting lithium. Such a material is a composite particle in which all or part of the surrounding face of a core particle composed of solid phase A is coated with solid phase B. The solid phase A contains at least one of silicon, tin, and zinc as an element. The solid phase B is a solid solution or an intermetallic compound composed of one of silicon, tin, and zinc as the element of the solid phase A; and at least one element selected from the group consisting of Group 2 elements, transition elements, Group 12 elements, Group 13 elements, and Group 14 elements other than carbon in the periodic table other than the foregoing elements of the phase A. One of the solid phase A and the solid phase B is amorphous.

Japanese Unexamined Patent Application Publication No. 2001-291512 (pp. 3, 4, 7, and 8 and FIG. 1) describes a cause of the increased irreversible capacity as follows. A crystalline system having a relatively large crystallite size and a clear crystal orientation has high crystallinity. Thus, when the volume change is generated to the degree that each texture of each crystallite is not able to be maintained by lithium insertion when charged, stress strain is easily generated mainly in the vicinity of grain boundary connecting each crystallite. In the result, a path for electron conductivity through the grain boundary is blocked, and thereby part of the active site is isolated and inactivated.

Further, Japanese Unexamined Patent Application Publication No. 2001-291512 (pp. 3, 4, 7, and 8 and FIG. 1) describes that an amorphous texture in which the crystallite size is extremely miniaturized, an amorphous texture in which partial disorder is generated with other element, or an amorphous texture in which the crystal orientation is randomized is used as an element of the anode material in order to prevent electric isolation of the active site. Thereby, the effect of the volume change of the anode material in the anode is minimized, the stress is relaxed, and the generation of irreversible capacity in the initial charge is kept to the minimum.

In Japanese Unexamined Patent Application Publication No. 2001-291512 (pp. 3, 4, 7, and 8 and FIG. 1), “amorphous” shows broad scattering band in which 2θ value has an apex in the range from 20 deg to 40 deg based on X-ray diffraction method using CuKα ray. A crystalline diffraction line may be therein included. In this case, it is desirable that the half-width of the peak in which the strongest diffraction intensity is shown is 0.6 deg or more based on 2θ value.

### SUMMARY OF THE INVENTION

As described above, in the anode using silicon or the like as an anode active material, a change in crystal structure due to charge and discharge cycle contributes to the generation of irreversible capacity. In Japanese Unexamined Patent Application Publication No. 2001-210315 (p. 2) and Japanese Unexamined Patent Application Publication No. 2001-291512 (pp. 3, 4, 7, and 8 and FIG. 1), the description is given that it is effective to non-crystallize the active material or part/all of the anode in order to inhibit initial generation of irreversible capacity in the anode. If it is correct, it is expected that amorphous effect is often obtained for the anode for the lithium secondary battery even if the anode for the lithium secondary battery is not particularly intended to inhibit generation of irreversible capacity, since the active material layer primarily composed of silicon formed by vapor-phase deposition method generally has an amorphous structure or a microcrystalline structure.

However, the inventors have found the followings after their keen researches. Firstly, they found that non-crystallization provides different effect to inhibit generation of irreversible capacity according to each case, and amorphous structure silicon includes various types of silicon having different degree of local orderliness. Secondly, they found that non-crystallization effect varies according to the different degree of local orderliness, and as the degree of local orderliness of the amorphous silicon is lower, reversibility of the anode active material is more improved, and the charge and discharge cycle characteristics of the battery are more improved.

In view of the foregoing, in the invention, it is desirable to provide an anode for secondary battery that is suitable for a lithium ion secondary battery and the like, has a high capacity and superior charge and discharge cycle characteristics, and in particular generates a small amount of irreversible capacity, a method of manufacturing it, and a secondary battery using it.

According to an embodiment of the invention, there is provided a first anode for secondary battery provided with an anode active material layer containing silicon on an anode current collector. Silicon in the anode active material layer has an amorphous structure. In a Raman spectrum of silicon having the amorphous structure after an initial charge and discharge, where an intensity of a scattering peak occurred in the vicinity of shift position 480 cm⁻¹ based on scattering due to transverse optical phonon is TO, an intensity of a scattering peak occurred in the vicinity of shift position 300 cm⁻¹ based on scattering due to longitudinal acoustic phonon is LA, and an intensity of a scattering peak occurred in the vicinity of shift position 400 cm⁻¹ based on scattering due to longitudinal optical phonon is LO, at least one of the following Condition expression 1 and Condition expression 2 is satisfied:

0.25≦LA/TO 1

0.45≦LO/TO 2

where the scattering peaks occurred in the vicinity of shift position 480 cm⁻¹, in the vicinity of shift position 300 cm⁻¹, and in the vicinity of shift position 400 cm⁻¹ respectively mean the largest scattering peaks occurred in the respective ranges of the shift position 480±10 cm⁻¹, the shift position 300±10 cm⁻¹, and the shift position 400±10 cm⁻¹.

According to an embodiment of the invention, there is provided a second anode for secondary battery provided with an anode active material layer containing silicon on an anode current collector. Silicon in the anode active material layer has an amorphous structure. In a Raman spectrum of silicon having the amorphous structure after an initial charge and discharge, where an intensity of a scattering peak occurred in the vicinity of shift position 480 cm⁻¹ based on scattering due to transverse optical phonon is TO, and an intensity of a scattering peak occurred in the vicinity of shift position 400 cm⁻¹ based on scattering due to longitudinal optical phonon is LO, Δ(LO/TO) as an increase of a ratio of LO to TO (LO/TO) due to 1 cycle of charge and discharge satisfies the following Condition expression 3:

Δ(LO/TO)≦0.020 3

where the scattering peaks occurred in the vicinity of shift position 480 cm⁻¹ and in the vicinity of shift position 400 cm⁻¹ respectively mean the largest scattering peaks occurred in the respective ranges of the shift position 480±10 cm⁻¹ and the shift position 400±10 cm⁻¹.

It has been expressed that Δ(LO/TO) is the increase of LO/TO due to 1 cycle of charge and discharge. In an actual measurement, the increase Δ(LO/TO) per 1 cycle may be obtained as follows. A plurality of cycles of charge and discharge are performed, an increase of LO/TO during such a plurality of cycles is divided by the number of cycles, and the resultant average value of the plurality of cycles is regarded as the increase portion Δ(LO/TO) per 1 cycle.

According to an embodiment of the invention, there is provided a secondary battery including the foregoing first or second anode for secondary battery according to the embodiments of the invention.

According to an embodiment of the invention, there is provided a first method of manufacturing an anode for secondary battery. In the method, after an anode current collector is prepared, an anode active material layer containing silicon is formed on the anode current collector by vacuum evaporation method in which deposition is performed at a deposition temperature of 500 deg C. or less or sputtering method in which deposition is performed at a deposition temperature of 230 deg C. or less. In the vacuum evaporation method, the deposition temperature is a temperature that is measured by, for example, contacting a thermocouple mounted on an anode current collector holding assembly with a face of the anode current collector opposite to a face on which the anode active material layer is formed in the anode active material layer formation region. In the sputtering method, the deposition temperature is a temperature of the anode current collector holding assembly itself measured by the thermocouple mounted on the anode current collector holding assembly in the anode active material layer formation region. According to an embodiment of the invention, there is provided a second method of manufacturing an anode for secondary battery. In the method, after an anode current collector is prepared, an anode active material layer containing silicon is formed on the anode current collector by sputtering method while a surface of the anode current collector is surrounded with an atmosphere having a pressure in the range from 1×10⁻² Pa to 5×10⁻¹ Pa.

As described above, in the anode using silicon as the anode active material, a change in crystal structure due to charge and discharge cycle contributes to generation of irreversible capacity. Thus, it is effective to non-crystallize silicon in order to inhibit generation of irreversible capacity in the anode. However, as the inventors have found, it is not enough that the anode active material is just non-crystallized. Silicon having an amorphous structure includes various silicon having different degrees of local disorderliness. As the disorderliness degree is lower, the reversibility of the anode active material is further improved and the charge and discharge cycle characteristics of the battery are further improved. In the result, it is important to keep the degree of local disorderliness low as much as possible.

To that end, first, it is necessary to establish a method to objectively determine the degree of local disorderliness of the amorphous silicon. In the embodiments of the invention, Raman spectroscopic analysis of the amorphous silicon was performed, and where the peak intensity of the scattering light due to transverse optical phonon occurred in the vicinity of shift position 480 cm⁻¹ is TO, the peak intensity of the scattering light due to longitudinal acoustic phonon occurred in the vicinity of shift position 300 cm⁻¹ is LA, and the peak intensity of the scattering light due to longitudinal optical phonon occurred in the vicinity of shift position 400 cm⁻¹ is LO, the relative intensity of LA and LO based on TO, that is, ratio LA/TO and ratio LO/TO are determined. As these ratios are larger, the degree of local disorderliness of the amorphous silicon is regarded lower.

In the crystalline silicon, the scattering light due to longitudinal acoustic phonon and the scattering light due to longitudinal optical phonon are not observed. Thus, as the amorphous silicon has relatively higher crystallinity and higher local disorderliness, these scattering light tend to be weaker. On the contrary, as the amorphous silicon has lower crystallinity and lower local disorderliness, these scattering lights tend to be stronger. Thus, the degree of local disorderliness of the amorphous silicon may be evaluated by measuring the intensity of these scattering lights, LA, and LO.

However, to experimentally determine the absolute intensity of the scattering light, many complicated steps are demanded. In the result, the accuracy is hardly obtained. Therefore, in the embodiments of the invention, the degree of local orderliness in the amorphous silicon is evaluated by using the relative intensity of LA and LO based on TO, that is, by using the ratio LA/TO and the ratio LO/TO instead of the absolute intensity of LA and LO. These ratios may be obtained by simple Raman spectroscopic analysis. Thus, compared to a case using the absolute intensity of LA and LO, the degree of local orderliness in the amorphous silicon may be extremely easily evaluated.

For the scattering light due to transverse optical phonon, the half-width of the peak tends to be narrower and the peak intensity TO tends to be larger as the local orderliness in the amorphous silicon is higher. Thus, in the case where the relative intensity based on TO is used, there is no possibility that it leads to a wrong conclusion practically.

In the first anode for secondary battery of the embodiment of the invention, the Raman spectrum of silicon after the initial charge and discharge satisfies at least one of Condition expression 1 and Condition expression 2. Thus, the local disorderliness in silicon having the amorphous structure is kept low sufficiently.

0.25≦LA/TO 1

0.45≦LO/TO 2

In the result, generation of irreversible capacity is prevented, for example, the lithium ion amount that is irreversibly inserted because of structural change due to charge and discharge cycle is small. In addition, superior charge and discharge cycle characteristics are realized, for example, the initial discharge capacity and the capacity retention ratio are large.

In the anode for the second secondary battery of the embodiment of the invention, in the Raman spectrum of silicon after the initial charge and discharge, Δ(LO/TO) as an increase of an LO/TO value due to 1 cycle of charge and discharge satisfies the following Condition expression 3:

Δ(LO/TO)≦0.020 3.

In general, every time charge and discharge are performed, the orderliness of the active material is lowered due to expansion and shrinkage, and thus the ratio LO/TO is increased. At this time, as the orderliness is higher, there is a high possibility that the orderliness is lowered and the increase Δ(LO/TO) of the ratio LO/TO due to 1 cycle of charge and discharge is larger. On the contrary, as the orderliness is lower, there is little possibility that the orderliness is lowered and the increase Δ(LO/TO) of the ratio LO/TO due to 1 cycle of charge and discharge is smaller. Thus, the foregoing Condition expression 3 (Δ(LO/TO)≦0.020) has a major point as follows. Since the local orderliness in amorphous silicon is kept low sufficiently, the increase Δ(LO/TO) of the ratio LO/TO due to 1 cycle of charge and discharge is small. That is, it may be stated that the foregoing Condition expression 3 is an expression paraphrasing Condition expression 1 and Condition expression 2 that are satisfied by the first anode for secondary battery from another viewpoint. Therefore, in the anode for second secondary battery of the embodiment of the invention, generation of irreversible capacity is prevented, and superior charge and discharge cycle characteristics are realized, for example, the initial discharge capacity and the capacity retention ratio are large as in the first anode for secondary battery.

The secondary battery of the embodiment of the invention includes the first anode for secondary battery and the second anode for secondary battery as an anode. Thus, the superior charge and discharge cycle characteristics as the characteristics of these anodes are actually occurred as superior charge and discharge cycle characteristics of the real battery.

Further, according to the first and the second methods of manufacturing an anode for secondary battery of the embodiments of the invention, the degree of local orderliness in the amorphous silicon is controlled by specifying the deposition conditions. Thus, the first and the second anodes for secondary battery may be securely manufactured. Compared to a case that an anode for secondary battery is formed without specifying the deposition conditions, an anode for secondary battery having superior charge and discharge cycle characteristics may be securely manufactured.

Other and further objects, features and advantages of the invention will appear more fully from the following description.

### BRIEF DESCRIPTION OF THE DRAWINGS

FIG. 1A is a diagram of Raman spectrums of amorphous silicon, polysilicon, and crystalline silicon, and FIG. 1B is an enlarged diagram of a Raman spectrum of amorphous silicon according to an embodiment of the invention;

FIGS. 2A and 2B are a perspective view and a cross section of a lithium ion secondary battery according to the embodiment of the invention;

FIGS. 3A and 3B are a graph showing a relation between an LA/TO value and a capacity retention ratio and a graph showing a relation between an LO/TO value and a capacity retention ratio according to examples of the invention;

FIG. 4 is a graph showing a relation between an increase Δ(LO/TO) of an LO/TO value per 1 cycle of charge and discharge and a capacity retention ratio according to the examples of the invention; and

FIG. 5 is a schematic view showing a configuration of an evaporation apparatus used in a method of manufacturing an anode for secondary battery in the invention.

### DETAILED DESCRIPTION OF THE PREFERRED EMBODIMENT

A first anode for secondary battery of the invention is desirably structured to satisfy at least one of the following Condition expression 4 and Condition expression 5:

0.28≦LA/TO 4

0.50≦LO/TO 5.

In this case, the degree of local orderliness of amorphous structure silicon composing an anode active material layer is kept low. Thus, the charge and discharge cycle characteristics are further improved.

In the first and a second anodes for secondary battery of the invention, at least part of the interface between an anode current collector and the anode active material layer is preferably alloyed. Further, it is preferable that at the interface therebetween, an element of the anode current collector is diffused in the anode active material layer, or an element of the anode active material layer is diffused in the anode current collector, or both the elements are diffused therein each other, and thereby the anode current collector and the anode active material layer are jointed. Thereby, the contact characteristics between the anode active material layer and the anode current collector are improved, the anode active material is prevented from being broken into parts because of expansion and shrinkage due to charge and discharge, and the anode active material layer is prevented from being dropped from the anode current collector. Further, it is possible to obtain effect that the electric conductivity in the first and the second anodes for secondary battery is improved. In the invention, alloying state includes the foregoing element diffusion and solid solution.

The anode active material layer is preferably formed by vapor-phase deposition method and/or firing method. The method of forming the anode active material layer is not particularly limited, and any method may be adopted as long as the anode active material layer composed of silicon having an amorphous structure may be formed on the anode current collector by the adopted method. For example, as the vapor-phase deposition method, any of vacuum evaporation method, sputtering method, ion plating method, laser ablation method, chemical vapor deposition (CVD) method, spray method and the like is cited. Further, the anode active material layer may be formed by two or more of the foregoing methods, or a combination of the foregoing method and another method.

The anode active material layer preferably contains 3 to 45 atomic % oxygen as an element, since oxygen inhibits expansion and shrinkage of the anode active material layer, and inhibits lowering of the discharge capacity and swollenness. At least part of oxygen contained in the anode active material layer is preferably bonded to silicon. The bonding state may be in the form of silicon monoxide, silicon dioxide, or in the form of other metastable state.

If the oxygen content ratio is smaller than 3 atomic %, it is difficult to obtain sufficient oxygen-containing effect. Meanwhile, if the oxygen content ratio is larger than 45 atomic %, the battery energy capacity may be lowered. In addition, the resistance value of the anode active material layer may be increased, swollenness may occur due to local lithium insertion, and the cycle characteristics may be lowered. The anode active material layer does not include a coat formed on the surface of the anode active material layer by decomposition of the electrolytic solution and the like due to charge and discharge. Thus, the oxygen content ratio in the anode active material layer is a numerical value calculated not including such a coat.

Further, as the anode active material layer, it is preferable that a plurality of first active material layers that do not contain oxygen or have a small oxygen content ratio and a plurality of second active material layers that have a large oxygen content are alternately provided. In this case, expansion and shrinkage due to charge and discharge are more effectively suppressed. For example, the silicon content ratio in the first active material layer is preferably 90 atomic % or more. The first active material layer may contain oxygen or may contain no oxygen. The oxygen content ratio thereof is preferably small. It is more preferable that the first active material layer does not contain oxygen at all, or has an extremely small oxygen content ratio. In this case, a higher discharge capacity may be obtained. Meanwhile, the silicon content ratio in the second active material layer is preferably 90 atomic % or less, and the oxygen content ratio in the second active material layer is preferably 10 atomic % or more. In this case, structural break due to expansion and shrinkage may be more effectively suppressed. Further, the oxygen content ratio is preferably changed gradually or continuously between the first active material layer and the second active material layer. It is because if the oxygen content is rapidly changed, the lithium ion diffusion characteristics may be lowered, and the resistance may be increased.

Further, as the anode current collector, a material containing copper is preferably used. As a metal element that does not form an intermetallic compound with lithium and is alloyed with silicon in the anode active material layer, copper, nickel, and iron are cited. Specially, copper is particularly preferable as a material, since thereby the anode current collector having a sufficient strength and conductivity may be obtained.

Further, a face of the anode current collector on which the anode active material layer is provided is preferably roughned. For example, the surface roughness value Rz of the anode current collector is preferably 1.0 μm or more. Thereby, the contact characteristics between the anode active material layer and the anode current collector are improved. The value Rz is preferably 5.5 μm or less, and more preferably 4.5 μm or less. If the surface roughness is excessively large, there is a possibility that a crack is easily generated in the anode current collector due to expansion of the anode active material layer. The surface roughness Rz means the ten point height of roughness profile Rz specified in JIS B 0601-1994. An electrolytic copper foil is preferable as a material of the anode current collector, since the electrolytic copper foil is made of a material containing copper and its surface is roughned.

Further, the anode active material layer preferably contains a metal element different from the component composing the current collector as an element.

A secondary battery of the invention is preferably structured as a lithium secondary battery in which a lithium compound is contained in a cathode active material composing a cathode. As a solvent composing an electrolyte, a cyclic ester carbonate having an unsaturated bond such as vinylene carbonate (VC) and vinylethylene carbonate (VEC) is preferably contained. Further, as a solvent composing the electrolyte, a fluorine-containing compound obtained by substituting part or all of hydrogen atoms of a cyclic ester carbonate and/or a chain ester carbonate is substituted with a fluorine atom such as difluoroethylene carbonate (DFEC) is preferably contained. In these cases, the charge and discharge cycle characteristics are further improved.

Further, the electrolyte preferably contains a sultone compound or a sulfone compound. The sultone compound is more preferably 1,3-propenesultone. Thereby a side reaction due to charge and discharge is prevented, and the cycle characteristics are prevented from being lowered due to deformation of the battery shape caused by gas expansion or the like.

Further, as an electrolyte salt composing the electrolyte, a compound having boron and fluorine as an element is preferable. In this case, the charge and discharge cycle characteristics are further improved.

In a method of manufacturing the anode for secondary battery of the invention, in deposition using vacuum evaporation method, the anode active material layer is preferably formed on the anode current collector at the deposition temperature of 200 deg C or more. In the vacuum evaporation method, the incidence energy of evaporation particles is small. Thus, to secure the contact characteristics of the anode active material layer to the anode current collector, the temperature of the anode current collector is desirably 200 deg C. or more.

A description will be hereinafter given of an embodiment of the invention with reference to the drawings.

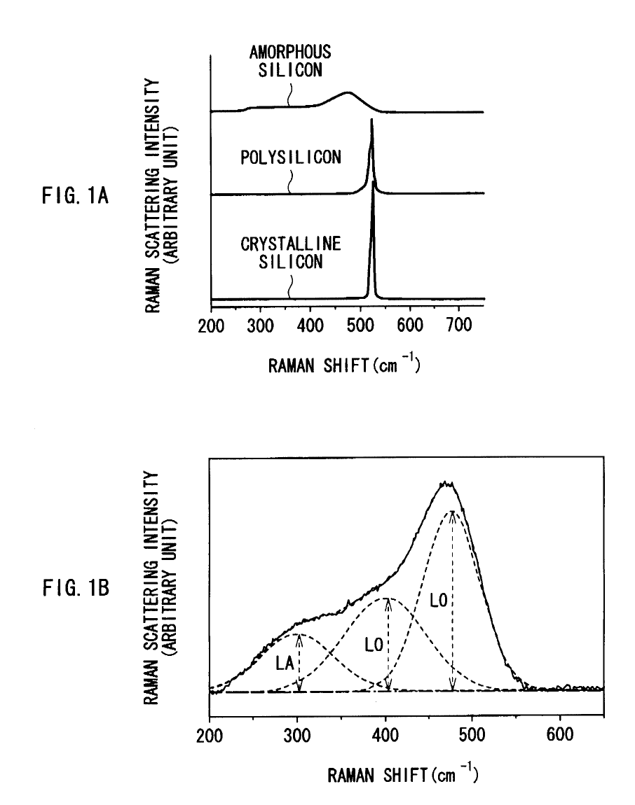

FIG. 1A is Raman spectrums of amorphous silicon, polysilicon, and crystalline silicon. FIG. 1B is an enlarged diagram of a Raman spectrum of amorphous silicon according to Example 8 described later. In the crystalline silicon, a scattering peak is observed only in the vicinity of shift position 520 cm⁻¹ corresponding to the crystal structure silicon. In the polysilicon, the wavenumber of the scattering peak corresponding to the foregoing crystal structure silicon is slightly shifted to the lower wavenumber side, the half-width is slightly increased, but its spectrum is not largely different from the spectrum of the crystalline silicon. Meanwhile, in the amorphous silicon, wide scattering peaks are observed in the vicinity of shift position 480 cm⁻¹, in the vicinity of shift position 400 cm⁻¹, and in the vicinity of shift position 300 cm⁻¹ corresponding to the amorphous structure.

The scattering peak occurred in the vicinity of shift position 480 cm⁻¹ is scattering light due to transverse optical phonon similar to the scattering peak occurred in the vicinity of shift position 520 cm⁻¹ of the crystalline silicon. As the local orderliness in the amorphous silicon is higher, the peak half-width tends to become narrower, the peak intensity tends to become stronger, and the peak wavenumber tends to approach the peak wavenumber of the crystalline silicon (520 cm⁻¹). Therefore, it is expected that the degree of local orderliness of the amorphous silicon may be evaluated by measuring the peak wavenumber, the peak intensity, and the half-width of the scattering peak. However, since the peak wavenumber of the scattering peak is affected by a stress as well, in some cases, the peak wavenumber of the scattering is not correlated with the degree of local disorderliness. Therefore, there is a possibility to lead wrong conclusion if the degree of local disorderliness in the amorphous silicon is determined by only the scattering peak occurred in the vicinity of shift position 480 cm⁻¹.

Meanwhile, the scattering peak occurred in the vicinity of shift position 330 cm⁻¹ is scattering light due to longitudinal acoustic phonon, and the scattering peak occurred in the vicinity of shift position 400 cm⁻¹ is scattering light due to longitudinal optical phonon. In the crystalline silicon, the scattering light due to longitudinal acoustic phonon and the scattering light due to longitudinal optical phonon are not observed. Thus, as the amorphous silicon has relatively higher crystallinity and higher local orderliness, these scattering lights tend to become weaker. On the contrary, as the amorphous silicon has lower crystallinity and lower local orderliness, these scattering lights tend to become stronger. Thus, the degree of local orderliness in the amorphous silicon may be evaluated by measuring the intensities of these scattering lights.

However, to experimentally determine the absolute intensity of the scattering light, many complicated steps are demanded. In the result, the accuracy is hardly obtained. Therefore, in the invention, where the peak intensity of the scattering light due to transverse optical phonon occurred in the vicinity of shift position 480 cm⁻¹ is TO, the peak intensity of the scattering light due to longitudinal acoustic phonon occurred in the vicinity of shift position 300 cm⁻¹ is LA, and the peak intensity of the scattering light due to longitudinal optical phonon occurred in the vicinity of shift position 400 cm⁻¹ is LO, the degree of local orderliness in the amorphous silicon is evaluated by using the relative intensity of LA and LO based on TO, that is, by using ratio LA/TO and ratio LO/TO.

These ratios may be obtained by a spectrum obtained by simple Raman spectroscopic analysis (refer to FIG. 1B). Thus, compared to a case using the absolute intensity of LA and LO, the degree of local orderliness in the amorphous silicon may be extremely easily evaluated. As described above, TO fundamentally tends to be larger as the local orderliness in the amorphous silicon is higher. Thus, when the relative intensity based on TO is used, there is no possibility that it leads to a wrong conclusion practically.

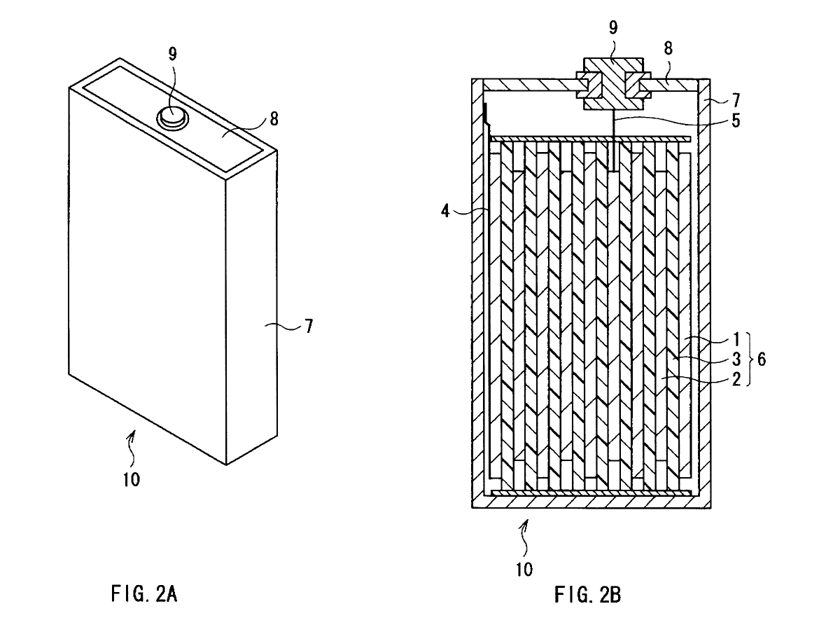

FIGS. 2A and 2B are a perspective view and a cross section that show an example of a structure of a lithium ion secondary battery based on this embodiment. As shown in FIGS. 2A and 2B, a secondary battery 10 is a square battery. A spirally wound electrode body 6 is contained in a battery can 7. An electrolytic solution is injected into the battery can 7. An opening of the battery can 7 is sealed by a battery cover 8. The spirally wound electrode body 6 is formed by layering a strip-shaped anode 1 and a strip-shaped cathode 2 with a separator (and an electrolyte layer) 3 in between, and spirally winding the resultant laminated body in the longitudinal direction. An anode lead terminal 4 derived from the anode 1 is connected to the battery can 7, and the battery can 7 also has a function as an anode terminal. A cathode lead terminal 5 derived from the cathode 2 is connected to a cathode terminal 9.

As a material of the battery can 7 and the battery cover 8, iron, aluminum and the like are used. However, in the case where the battery can 7 and the battery cover 8 made of aluminum are used, it is preferable that to prevent reaction between lithium and aluminum, the cathode lead terminal 5 is welded to the battery can 7 and the anode lead terminal 4 is connected to the terminal pin 9.

A description will be hereinafter given of the lithium ion secondary battery 10.

The anode 1 is composed of an anode current collector and an anode active material layer provided on the anode current collector. The foregoing anode for secondary battery is used by being cut into a given shape.

The anode current collector is preferably made of a metal material not forming an intermetallic compound with lithium (Li). If the anode current collector is made of a material forming an intermetallic compound with lithium, the anode current collector is expanded or shrunk because of reaction with lithium due to charge and discharge. In the result, structural break of the anode current collector is caused, and the current collectivity characteristics are lowered. Further, the ability to retain the anode active material layer is lowered, and the anode active material layer is easily dropped from the anode current collector.

As the metal element not forming an intermetallic compound with lithium, for example, copper (Cu), nickel (Ni), titanium (Ti), iron (Fe), chromium (Cr) or the like is cited. In the specification, the metal material includes an alloy composed of two or more metal elements or composed of one or more metal elements and one or more semimetal elements (metalloid element), in addition to a simple substance of a metal element.

It is preferable that the anode current collector is made of a metal material containing a metal element being alloyed with the anode active material layer. Thereby, the contact characteristics between the anode active material layer and the anode current collector are improved, the anode active material is prevented from being broken into parts because of expansion and shrinkage due to charge and discharge, and the anode active material is prevented from being dropped from the anode current collector. Further, it is possible to obtain effect that the electric conductivity in the anode 1 is improved.

As a metal element that does not form an intermetallic compound with lithium and is alloyed with silicon in the anode active material layer, copper, nickel, and iron are cited. Specially, copper is particularly preferable as a material, since thereby the anode current collector having a sufficient intensity and conductivity is obtained.

The anode current collector may have a single layer structure or a multilayer structure. In the case where the anode current collector has the multilayer structure, it is preferable that the layer adjacent to the anode active material layer is made of the metal material being alloyed with silicon, and layers not adjacent to the anode active material layer are made of the metal material not forming an intermetallic compound with lithium.

A face of the anode current collector on which the anode active material layer is provided is preferably roughned. For example, the surface roughness value Rz of the anode current collector is preferably 1.0 μm or more. Thereby, the contact characteristics between the anode active material layer and the anode current collector are improved. In addition, the value Rz is preferably 5.5 μm or less, and more preferably 4.5 μm or less. If the surface roughness is excessively large, there is a possibility that a crack is easily generated in the anode current collector due to expansion of the anode active material layer. It is enough that the surface roughness Rz of the region provided with the anode active material layer in the anode current collector is within the foregoing range.

The anode active material layer contains silicon as an anode active material. Silicon has superior ability to alloy lithium ions and insert the alloyed lithium, and superior ability to extract again the alloyed lithium as lithium ions. Thus, in the case where the lithium ion secondary battery is structured with the use of silicon, a higher energy density may be realized. Silicon may be contained in the form of the simple substance, an alloy, or a compound. Silicon may be contained in a state that two or more thereof are mixed.

The anode active material layer is preferably ultrathin, being about from 4 to 7 μm thick. At this time, part or all of silicon simple substance is preferably alloyed with the anode current collector. As described above, the contact characteristics between the anode active material layer and the anode current collector may be thereby improved. Specifically, it is preferable that at the interface therebetween, an element of the anode current collector is diffused in the anode active material layer, or an element of the anode active material layer is diffused in the anode current collector, or both the elements are diffused therein each other. Thereby, even if the anode active material layer is expanded and shrunk due to charge and discharge, the anode active material layer is prevented from being dropped from the anode current collector. In the present application, alloying state includes the foregoing element diffusion and solid solution.

As the element composing the anode active material layer, oxygen is preferably contained. Oxygen inhibits expansion and shrinkage of the anode active material layer, and inhibits lowering of the discharge capacity and swollenness. At least part of oxygen contained in the anode active material layer is preferably bonded to silicon. The bonding state may be in the form of silicon monoxide, silicon dioxide, or in the form of other metastable state.

The oxygen content in the anode active material layer is preferably in the range from 3 atomic % to 45 atomic %. Ifn the oxygen content is smaller than 3 atomic %, it is difficult to obtain sufficient oxygen-containing effect. Meanwhile, if the oxygen content is larger than 45 atomic %, the battery energy capacity may be lowered, the resistance value of the anode active material layer may be increased, swollenness may occur due to local lithium insertion, and the cycle characteristics may be lowered. The anode active material layer does not include a coat formed on the surface of the anode active material layer by decomposition of the electrolytic solution and the like due to charge and discharge. Thus, the oxygen content in the anode active material layer is a numerical value calculated not including such a coat.

Further, in the anode active material layer, it is preferable that a first layer that has a small oxygen content and a second layer that has a larger oxygen content than that of the first layer are alternately layered. One or more second layers preferably exist at least between the first layers. In this case, expansion and shrinkage due to charge and discharge are more effectively suppressed. For example, the silicon content in the first layer is preferably 90 atomic % or more. The first layer may contain oxygen or may contain no oxygen. The oxygen content thereof is preferably small. It is more preferable that the first layer does not contain oxygen at all, or has an extremely small oxygen content. In this case, a higher discharge capacity may be obtained. Meanwhile, the silicon content in the second layer is preferably 90 atomic % or less, and the oxygen content in the second layer is preferably 10 atomic % or more. In this case, structural break due to expansion and shrinkage may be more effectively suppressed. Further, the oxygen content is preferably changed gradually or continuously between the first layer and the second layer. If the oxygen content is rapidly changed, the lithium ion diffusion characteristics may be lowered, and the resistance may be increased.

The anode active material layer may contain one or more elements other than silicon and oxygen. As other element, for example, titanium (Ti), chromium (Cr), manganese (Mn), iron (Fe), cobalt (Co), nickel (Ni), copper (Cu), zinc (Zn), indium (In), silver (Ag), magnesium (Mg), aluminum (Al), germanium (Ge), tin (Sn), bismuth (Bi), or antimony (Sb) is cited.

The cathode 2 is composed of a cathode current collector and a cathode active material layer provided on the cathode current collector.

The cathode current collector is preferably made of, for example, a metal material such as aluminum, nickel, and stainless.

It is preferable that the cathode active material layer contains one or more cathode active materials capable of extracting lithium ions when charged and inserting again the lithium ions when discharged. If necessary, the cathode active material layer preferably contains a conductive material such as a carbon material and a binder such as polyvinylidene fluoride.

As the material capable of extracting lithium ions and inserting again the lithium ions, for example, a lithium transition metal composite oxide composed of lithium and transition metal element M that is expressed as general formula LiₓMO₂ is preferable. In the case where the lithium ion secondary battery is structured, the lithium transition metal composite oxide may realize a still higher capacity of the secondary battery, since the lithium transition metal composite oxide may generate high electromotive force and has a high density. M is one or more transition metal elements. For example, M is preferably at least one of cobalt and nickel. x varies according to battery charge state (discharge state), and generally is a value in the range of 0.05≦x≦1.10. Specific examples of such a lithium transition metal composite oxide include LiCoO₂, LiNiO₂, and the like.

In the case of using a particulate lithium transition metal composite oxide as a cathode active material, its powder may be directly used. Otherwise it is possible to provide a surface layer containing at least one selected from the group consisting of an oxide having a composition different from that of the lithium transition metal composite oxide, a halide, a phosphate, and a sulfate for at least part of the particulate lithium transition metal composite oxide. Thereby, the stability may be improved, and lowering of the discharge capacity may be further suppressed. In this case, the element of the surface layer and the element of the lithium transition metal composite oxide may be diffused in each other.

Further, the cathode active material layer preferably contains at least one selected from the group consisting of simple substances and compounds of Group 2 elements, Group 3 elements, or Group 4 elements in the long period periodic table. Thereby, the stability may be improved and lowering of the discharge capacity may be further suppressed. As the Group 2 element, magnesium (Mg), calcium (Ca), strontium (Sr) or the like is cited. Specially, magnesium is preferable. As the Group 3B element, scandium (Sc), yttrium (Y) or the like is cited. Specially, yttrium is preferable. As the Group 4 element, titanium or zirconium (Zr) is cited. Specially, zirconium is preferable. These elements may be solid-solved in the cathode active material. Otherwise, these elements may exist as a simple substance or a compound in the grain boundary of the cathode active material.

The separator 3 separates the cathode 2 from the anode 1, and passes lithium ions while preventing current short circuit due to contact of the both electrodes. As a material of the separator 3, for example, it is preferable to use a microporous thin film made of polyethylene, polypropylene or the like in which many minute voids are formed.

The electrolytic solution contains, for example, a solvent and an electrolyte salt dissolved in the solvent, and if necessary may contain an additive.

As the solvent of the electrolytic solution, for example, a nonaqueous solvent such as a cyclic ester carbonate such as 1,3-dioxolane-2-one (ethylene carbonate: FEC) and 4-methyl-1,3-dioxolane-2-one (propylene carbonate: PC); and a chain ester carbonate such as dimethyl carbonate (DMC), diethyl carbonate (DEC), and ethylmethyl carbonate (EMC) is cited. One of the solvents may be used singly, but two or more thereof are preferably used by mixing. For example, when a high-dielectric solvent such as EC and PC and a low-viscosity solvent such as DMC, DEC, and EMC are used by mixing, high solubility to the electrolyte salt and high ion conductivity may be realized.

Further, the solvent may contain sultone, since thereby the stability of the electrolytic solution is improved, and the battery swollenness due to decomposition reaction or the like may be prevented. Sultone preferably has an unsaturated bond in the cycle. In particular, 1,3-propenesultone (PRS) having the following structural formula is preferable, since thereby higher effects may be obtained.

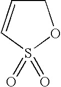

Further, for the solvent, a cyclic ester carbonate having an unsaturated bond such as 1,3-dioxol-2-one (vinylene carbonate: VC) and 4-vinyl-1,3-dioxolane-2-one (vinylethylene carbonate: VEC) is preferably used by mixing. Thereby, lowering of the discharge capacity may be further suppressed. In particular, VC and VEC are preferably used together, since thereby higher effects may be obtained.

Further, for the solvent, an ester carbonate derivative having a halogen atom may be used by mixing, since thereby lowering of the discharge capacity may be prevented. In this case, the ester carbonate derivative having a halogen atom is more preferably used by being mixed with the cyclic ester carbonate having an unsaturated bond, since thereby higher effects may be obtained. The ester carbonate derivative having a halogen atom may be a cyclic compound or a chain compound. The cyclic compound is more preferable since thereby higher effects may be obtained. As the cyclic compound, 4-fluoro-1,3-dioxolane-2-one (fluoroethylene carbonate: FEC), 4-chloro-1,3-dioxolane-2-one, 4-bromo-1,3-dioxolane-2-one, 4,5-difluoro-1,3-dioxolane-2-one (difluoroethylene carbonate: DFEC) or the like is cited. Specially, DFEC and FEC having a fluorine atom are preferable, and DFEC is particularly preferable, since thereby higher effects may be obtained.

As the electrolyte salt of the electrolytic solution, for example, a lithium salt such as lithium hexafluorophosphate (LiPF₆) and lithium tetrafluoroborate (LiBF₄) is cited. One of these electrolyte salts may be used singly, or two or more thereof may be used by mixing.

The electrolytic solution may be used directly, or may be used as a so-called gel electrolyte in which the electrolytic solution is supported by a polymer compound. In this case, the electrolyte may be impregnated in the separator 3, or may exist in a state of a layer between the separator 3 and the anode 1/the cathode 2. As the polymer material, for example, a polymer containing vinylidene fluoride is preferable, since such a polymer has high redox stability. As the polymer compound, a compound formed by polymerizing a polymerizable compound is also preferable. As the polymerizable compound, for example, a monofunctional acrylate such as acrylic ester, a monofunctional methacrylate such as methacrylic ester, a multifunctional acrylate such as diacrylic ester and triacrylic ester, a multifunctional methacrylate such as dimethacrylic ester and trimethacrylic ester, acrylonitrile, methacrylonitrile or the like is cited. Specially, an ester having an acrylate group or a methacrylate group is preferable, since thereby polymerization easily proceeds and the reaction ratio of the polymerizable compound is high.

The lithium ion secondary battery 10 may be manufactured, for example, as follows.

First, after the anode active material layer is formed on the anode current collector, the resultant is cut into a given shape to form the anode 1.

The method of forming the anode active material layer is not particularly limited, and any method is adopted as long as the anode active material layer may be formed on the anode current collector with the use of the adopted method. For example, vapor-phase deposition method, firing method, and liquid-phase deposition method are cited. As the vapor-phase deposition method, any of sputtering method, ion plating method, laser ablation method, chemical vapor deposition (CVD) method, spray method and the like may be used in addition to the vacuum evaporation method. As the liquid-phase deposition method, for example, plating is cited. The anode active material layer may be formed by two or more of the foregoing methods, or a combination of the foregoing method and another method.

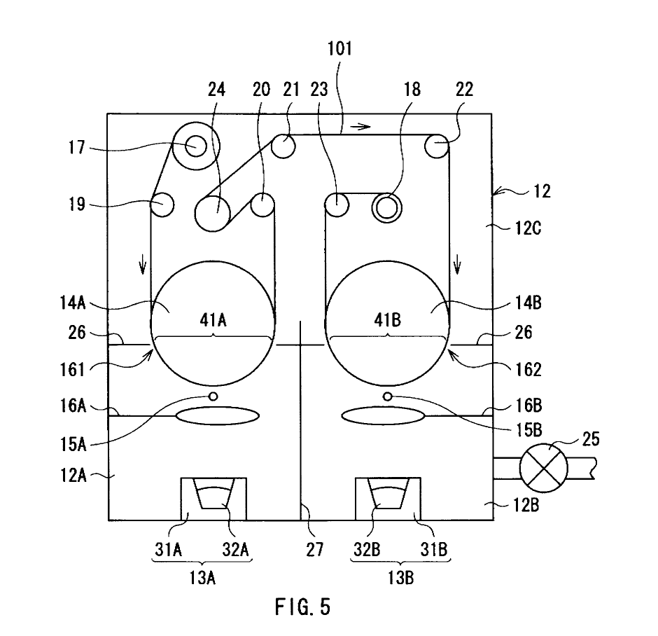

In the case where the anode active material layer is formed by the vacuum evaporation method, for example, the electron beam evaporation apparatus (hereinafter simply referred to as evaporation apparatus) shown in FIG. 5 may be used. FIG. 5 is a schematic view showing a configuration of the evaporation apparatus used in manufacturing the anode of this embodiment. In the evaporation apparatus, as will be described later, evaporation materials 32A and 32B composed of silicon contained in crucibles 31A and 31B are vaporized and deposited on the surface of a strip-shaped anode current collector 101 retained by can rolls 14A and 14B, and thereby the anode active material layer is formed.

In the evaporation apparatus, vaporization sources 13A and 13B, the can rolls (deposition rolls) 14A and 14B, gas introduction nozzles 15A and 15B, shutters 16A and 16B, wind-up rollers 17 and 18, guide rollers 19 to 23, and a feed roller 24 are included in an evaporation treatment bath 12. Outside the evaporation bath 12, a vacuum air exhaust 25 is provided.

The evaporation treatment bath 12 is segmented into vaporization source installation chambers 12A and 12B and an evaporated object running chamber 12C by a division plate 26. The vaporization source installation chambers 12A and 12B are separated by a division wall 27. In the vaporization source installation chamber 12A, the gas introduction nozzle 15A and the shutter 16A are installed in addition to the vaporization source 13A. In the other vaporization source installation chamber 12B, the gas introduction nozzle 15B and the shutter 16B are installed in addition to the vaporization source 13B. For the details of the vaporization sources 13A and 13B, the gas introduction nozzles 15A and 15B, and the shutters 16A and 16B, a description will be given later.

In the evaporated object running chamber 12C, the can rolls 14A and 14B are respectively installed above the vaporization sources 13A and 13B. However, the division plate 26 is provided with openings 161 and 162 in two locations corresponding to the can rolls 14A and 14B, and part of the can rolls 14A and 14B is projected into the vaporization source installation chambers 12A and 12B. In the evaporated object running chamber 12C, as a means for retaining the anode current collector 101 and running the anode current collector 101 in the longitudinal direction, the wind-up rollers 17 and 18, the guide rollers 19 to 23, and the feed roller 24 are arranged in respective given positions.

The anode current collector 101 is in a state that its one end side is wound up by the wind-up roller 17, and the other end side is attached to the wind-up roller 18 through the guide roller 19, the can roll 14A, the guide roller 20, the feed roller 24, the guide roller 21, the guide roller 22, the can roll 14B, and the guide roller 23 in this order from the wind-up roller 17. The anode current collector 101 is arranged to be contacted with each outer circumferential plane of the wind-up rollers 17 and 18, the guide rollers 19 to 23, and the feed roller 24. One face (front face) of the anode current collector 101 is in contact with the can roll 14A, and the other face (rear face) is in contact with the can roll 14B. The wind-up rollers 17 and 18 are drive system. Thus, the anode current collector 101 may be sequentially conveyed from the wind-up roller 17 to the wind-up roller 18, and may be sequentially conveyed from the wind-up roller 18 to the wind-up roller 17. FIG. 5 shows a state that the anode current collector 101 is run from the wind-up roller 17 to the wind-up roller 18, and the arrow in the figure indicates the direction in which the anode current corrector 101 is moved. Further, in the evaporation apparatus, the feed roller 24 is also a drive-train.

The can rolls 14A and 14B are a rotating body (drum) in the shape of a cylinder or the like for retaining the anode current collector 101. The can rolls 14A and 14B rotate (rotate on its axis) and thereby part of the outer circumferential plane sequentially enters the vaporization source installation chambers 12A and 12B to oppose the vaporization sources 13A and 13B. Then, in the outer circumferential plane of the can rolls 14A and 14B, portions 41A and 41B entering the vaporization source installation chambers 12A and 12B become evaporation regions in which the anode active material layer is formed from the evaporation materials 32A and 32B from the vaporization sources 13A and 13B.

In the vaporization sources 13A and 13B, the evaporation materials 32A and 32B are contained in the crucibles 31A and 31B. The evaporation materials 32A and 32B are heated and thereby vaporized (volatilized). Specifically, the vaporization sources 13A and 13B further include, for example, an electron gun (not shown). A thermal electron is emitted by driving the electron gun. For example, the range of the thermal electron is electromagnetically controlled by a deflection yoke (not shown), while being radiated onto the evaporation materials 32A and 32B contained in the crucibles 31A and 31B. The evaporation materials 32A and 32B are heated by irradiation of the thermal electron from the electron gun, melted, and then gradually vaporized.

The crucibles 31A and 31B are made of, for example, an oxide such as titanium oxide, tantalum oxide, zirconium oxide, and silicon oxide in addition to carbon. To prevent temperatures of the crucibles 31A and 31B from being excessively increased due to irradiation of the thermal electron onto the evaporation materials 32A and 32B, part of the surroundings of the crucibles 31A and 31B (for example, the bottom face) may be contacted with a cooling system (not shown). As the cooling system, for example, a water-cooling chiller such as a water jacket is suitable.

The shutters 16A and 16B are an openable and closable mechanism that is arranged between the vaporization sources 13A and 13B and the can rolls 14A and 14B, and controls the vapor-phase evaporation materials 32A and 32B passing from the crucibles 31A and 31B to the anode current collector 101 retained by the can rolls 14A and 14B. That is, in the evaporation treatment, the shutters 16A and 16B are opened to allow the vapor-phase evaporation materials 32A and 32B vaporized from the evaporation materials 32A and 32B to pass. Meanwhile, before and after the evaporation treatment, the shutters 16A and 16B block the vapor-phase evaporation materials 32A and 32B. The shutters 16A and 16B are connected to a control circuit system (not shown). When a command signal to open or close the shutters 16A and 16B is inputted, the shutters 16A and 16B are driven.

The gas introduction nozzles 15A and 15B are a piping to exhaust inert gas such as argon (Ar) gas so that the surface of the anode current collector 101 retained by the can rolls 14A and 14B are surrounded with the gas. FIG. 5 shows a state that its opening is oriented to a viewer side of the figure. The exhaust direction of the inert gas is not particularly limited. The flow of the inert gas is controlled by, for example, a mass flow controller linked to the gas introduction nozzles 15A and 15B outside of the evaporation treatment bath 2. The number of the introduction nozzles 15A and 15B may be respectively 1 or more. When the inert gas is introduced, the vapor-phase evaporation materials 32A and 32B go to the anode current collector 101 are moderately scattered in the vicinity of the surface of the anode current collector 101 in the evaporation region. In the result, the anode active material layer composed of silicon that has a preferable amorphous structure in which the local disorderliness is sufficiently decreased is evaporated on the anode current collector 101. When the anode active material layer is formed by covering the surface of the anode current collector 101 with an atmosphere (inert gas) having a pressure of from 1×10⁻² Pa to 5×10⁻¹ Pa, particularly preferably with an atmosphere (inert gas) having a pressure of from 2×10⁻² Pa to 1.5×10⁻¹ Pa by adjusting the gas flow (introduction amount), a more favorable amorphous structure is obtained, which is suitable for improving the cycle characteristics. In this case, the anode active material layer is preferably formed at the deposition rate in the thickness direction of, for example, from 80 nm/s to 2 μm/s. Thereby, a more favorable amorphous structure is obtained. The pressure of the atmosphere covering the surface of the anode current collector 101 may be measured by a pressure gauge (not shown) such as an ionization gauge. The deposition rate may be measured by, for example, installing a quartz monitor (not shown) in the evaporation treatment bath 2.

In the case where oxygen is contained in the anode active material layer, the oxygen content is adjusted by, for example, containing oxygen in the atmosphere in forming the anode active material layer, by containing oxygen in the atmosphere in firing treatment or heat treatment, or by the oxygen content of the anode active material particle to be used.

Further, as described above, in the case where the first layer that has a small oxygen content and the second layer that has a larger oxygen content than that of the first layer are alternately layered to form the anode active material layer, the oxygen content may be adjusted by changing the oxygen concentration in the atmosphere. Further, it is possible that after the first layer is formed, the surface is oxidized to form the second layer.

It is possible that after the anode active material layer is formed, heat treatment is performed under the vacuum atmosphere or under the non-oxidizing atmosphere, and thereby the interface between the anode current collector and the anode active material layer is further alloyed.

Next, the cathode active material layer is formed on the cathode current collector. For example, a cathode active material, and if necessary a conductive material and a binder are mixed to prepare a mixture. The mixture is dispersed in a dispersion medium such as NMP to obtain mixture slurry. The cathode current collector is coated with the mixture slurry, and then the resultant is compression-molded to form the cathode 2.

Next, the anode 1 and the cathode 2 are layered with the separator 3 in between, the resultant laminated body is spirally wound with the short side direction as the winding axis direction to form the spirally wound electrode body 6. The anode 1 and the cathode 2 are arranged so that the anode active material layer is opposed to the cathode active material layer. Next, the spirally wound electrode body 6 is inserted in the square battery can 7, and the battery cover 8 is welded to the opening of the battery can 7. Next, after the electrolytic solution is injected through an electrolytic solution injection hole formed in the battery cover 8, the injection hole is sealed. Consequently, the square lithium ion secondary battery 10 is assembled.

Further, in the case where the electrolytic solution is supported by the polymer compound, the polymerizable compound is injected together with the electrolytic solution into a container made of a package member such as a laminated film, the polymerizable compound is polymerized in the container, and thereby the electrolyte is gelated. Further, to address large expansion and shrinkage of the electrode, a metal can may be used as the container. Further, it is possible that before the anode 1 and the cathode 2 are spirally wound, the anode 1 or the cathode 2 is covered with a gel electrolyte by coating method or the like, and then the anode 1 and the cathode 2 are layered with the separator 3 in between and spirally wound.

After the lithium ion secondary battery 10 is assembled, when the lithium ion secondary battery 10 is charged, lithium ions are extracted from the cathode 2, moved to the anode 1 side through the electrolytic solution, and reduced in the anode 1. The generated lithium forms an alloy with the anode active material, which is inserted in the anode 1. When the lithium ion secondary battery 10 is discharged, the lithium inserted in the anode 1 is extracted again as lithium ions, moved to the cathode 2 side through the electrolytic solution, and inserted again into the cathode 2.

In the lithium ion secondary battery 10, the silicon substance and a compound thereof are contained as an anode active material in the anode active material layer. Thus, the capacity of the secondary battery may be improved.

### EXAMPLES

Examples of the invention will be hereinafter described in detail. In the following description, the symbols used in the embodiment will be directly used accordingly.

### Examples 1 to 3

In these examples, the anode active material layer was formed on the anode current collector by vacuum evaporation method, the resultant was used as the anode 1, and thereby the square lithium ion secondary battery 10 shown in FIGS. 2A and 2B in the embodiment was fabricated. Then, the charge and discharge cycle characteristics were measured. A description will be specifically given.

First, the anodes 1 that have amorphous silicon with various degree of local orderliness as the anode active material layer were formed as follows.

When the anode 1 was formed, as an electrode formation apparatus, the vacuum evaporation apparatus shown in FIG. 5 was used. As the anode current collector, a strip-shaped electrolytic copper foil having a thickness of 24 μm, the surface roughness value Rz of 2.5 μm, and the roughned both faces was used to form the anode 1. As an evaporation material, silicon single crystal was used. The deposition rate was from 50 to 100 nm/s. Then, the anode active material layer being from 5 to 6 μm thick was formed. An inert gas or other gas were not introduced from the gas introduction nozzles 15A and 15B. When the anode active material layer was formed, the pressure in the vacuum chamber including in the vicinity of the surface of the anode current collector in the evaporation region was kept about 5×10⁻³ Pa. The anode active material layer was oxidized by oxygen remaining in the vacuum chamber or the like to contain about 2 atomic % oxygen.

To change the degree of local orderliness of the anode active material layer to be formed, deposition was performed by variously changing the temperature of the anode current collector in the evaporation region in the range from 200 deg C. to 500 deg C., in the foregoing deposition rate range. The temperature of the anode current collector was kept at a given temperature by adjusting heat carried by the deposition material and radiation heat from the evaporation source. The temperature of the anode current collector was measured by contacting a thermocouple mounted on an anode current collector holding assembly with the face of the anode current collector opposite to the face on which the anode active material layer was formed.

In all examples, it was confirmed that separation or the like resulting from excessive alloying of copper and silicon (for example, formation of Cu₃Si) was not generated at the interface between the anode current collector and the anode active material layer. If the excessive alloying proceeds at the interface between the anode current collector and the anode active material layer due to the heat in evaporation, the anode active material is separated and the cycle characteristics are lowered, and thus such an excessive alloying should be prevented.

Specific conditions of the deposition rate and the temperature (deposition temperature) of the anode current collector in the evaporation region were, as shown in Table 1 mentioned later, 100 nm/s and 500 deg C. in Example 1, 80 nm/s and 440 deg C. in Example 2, and 50 nm/s and 410 deg C. in Example 3.

After the anode 1 was formed, lithium cobalt oxide (LiCoO₂) powder having an average particle diameter of 5 μm as a cathode active material, carbon black as an electrical conductor, and polyvinylidene fluoride (PVdF) as a binder were mixed at a weight ratio of lithium cobalt oxide:carbon black:polyvinylidene fluoride=92:3:5 to prepare a mixture. The mixture was dispersed in N-methylpyrrolidone NMP as a disperse medium to obtain mixture slurry. The cathode current collector made of an aluminum foil being 15 μm thick was coated with the mixture slurry, and the disperse medium was vaporized and the resultant was dried. After that, the resultant was pressurized and compression-molded. Thereby, the cathode active material layer was formed and the cathode 2 was formed.

Next, the anode 1 and the cathode 2 were layered with the separator 3 in between, the resultant laminated body was spirally wound to form the spirally wound electrode body 6. As the separator 3, a multilayer separator being 23 μm thick in which a microporous polyethylene film as a center material was sandwiched between microporous polypropylene films was used.

Next, the spirally wound electrode body 6 was inserted in the square battery can 7. The battery cover 8 was welded to the opening of the battery can 7. Next, after an electrolytic solution was injected through the electrolytic solution injection hole formed in the battery cover 8, the injection hole was sealed. Consequently, the lithium ion secondary battery 10 was assembled.

As the electrolytic solution, a solution obtained by dissolving LiPF₆ at a concentration of 1 mol/dm³ as an electrolyte salt in a mixed solvent in which ethylene carbonate (EC) and diethyl carbonate (DEC) were mixed at a weight ratio of EC:DEC=30:70 was used as a normal electrolytic solution.

As Comparative example 1 relative to Examples 1 to 3, the lithium ion secondary battery 10 was formed in the same manner as that of Example 1, except that the temperature (deposition temperature) of the anode current collector was 600 deg C. by shortening the distance between the evaporation source and the anode current collector and arranging the installation for easily applying heat to the anode current collector while the deposition rate was 100 nm/s identical with that of Example 1.

### Evaluation of Lithium Ion Secondary Battery

For the fabricated lithium ion secondary batteries 10 of Examples 1 to 3 and Comparative example 1, a charge and discharge cycle test was performed at 25 deg C., and the discharge capacity retention ratio was measured. In the charge and discharge cycle test, first, only for the first cycle, charge was performed at the constant current of 0.2 mA/cm² until the battery voltage reached 4.2 V, charge was continuously performed at the constant voltage of 4.2 V until the current density reached 0.05 mA/cm², and then discharge was performed at the constant current of 0.2 mA/cm² until the battery voltage reached 2.5 V. For each 1 cycle on and after the second cycle, first, charge was performed at the constant current of 2 mA/cm² until the battery voltage reached 4.2 V, charge was continuously performed at the constant voltage of 4.2 V until the current density reached 0.1 mA/cm², and then discharge was performed at the constant current of 2 mA/cm² until the battery voltage reached 2.5 V.

50 cycles of the foregoing charge and discharge cycle were performed at 25 deg C., and the capacity retention ratio at the 50th cycle (ratio of the discharge capacity at the 50th cycle to the discharge capacity at the second cycle) that is defined by the following formula was examined:

Capacity retention ratio (%) at the 50th cycle to the discharge capacity at the second cycle=(discharge capacity at the 50th cycle/discharge capacity at the second cycle)×100%.

### Raman Spectroscopic Analysis

Separately from the foregoing, for the lithium ion secondary battery 10, batteries after the initial (first cycle) discharge and batteries after the 10th cycle discharge were disassembled. The electrode thereof was washed with dimethyl carbonate (DMC), dried, and then the anode active material layer composed of the amorphous silicon was provided with Raman spectroscopic analysis to determine the degree of local disorderliness in the amorphous silicon. For Raman spectroscopic analysis, two of the anode active material layers were taken out randomly, and then the respective measurement values thereof were obtained, and the average value thereof was used.

The measurement conditions of Raman spectroscopic analysis were as follows:

Light source: argon ion laser (wavelength: 488 nm, beam diameter: 100 μm, S polarization)

Measurement mode: macro Raman (measurement arrangement: 60 degree scattering)

Scattering light: (S+P) polarization

Spectroscope: T-64000 (Jobin Yvon make, diffraction grating: 1800 gr/mm, slit: 100 μm)

Detector: CCD (Jobin Yvon make)

In these examples, in the same manner as in the embodiment, the peak intensity TO of the scattering light due to transverse optical phonon occurred in the vicinity of shift position 480 cm⁻¹, the peak intensity LA of the scattering light due to longitudinal acoustic phonon occurred in the vicinity of shift position 300 cm⁻¹, and the peak intensity LO of the scattering light due to longitudinal optical phonon occurred in the vicinity of shift position 400 cm⁻¹ were measured from the Raman spectrums of the amorphous silicon. Then, the relative intensity of LA and LO based on TO, that is, the ratio LA/TO and the ratio LO/TO were obtained. As these ratios were larger, the degree of local orderliness in the amorphous silicon was evaluated lower. The capacity retention ratio and the measurement results of Raman spectroscopic analysis were shown in Table 1 together with the deposition conditions.

In table 1, Δ(LO/TO) as the average of 9 cycles was obtained as follows. An increase of LO/TO value in 9 cycles from the second cycle to the 10th cycle was obtained based on the difference between the LO/TO value after the 10th cycle and the LO/TO value after the initial cycle. The obtained increase was divided by 9 as the number of cycles, and thereby Δ(LO/TO) as the increase per 1 cycle was calculated.

In Table 1, LA/TO value and LO/TO value after deposition were measurement values for the active material layer of the anode in the period from when the active material layer was deposited to when the battery was fabricated. Meanwhile, LA/TO value and LO/TO value after the initial cycle were measurement values for the active material layer of the anode in the period from when the battery was fabricated to when the first charge and discharge was performed.

TABLE 1
Deposition method of anode active material layer: vacuum evaporation
method

| | | | | | | | | Average | |
|---|---|---|---|---|---|---|---|---|---|
| | | | | | | | After | of 9 | Capacity |
| | Deposition | Deposition | | | After initial | | 10th | cycles | retention |
| | rate | temperature | After deposition | | cycle | | cycle | Δ | ratio |
| | nm/s | deg C. | LA/TO | LO/TO | LA/TO | LO/TO | LO/TO | (LO/TO) | % |
| Comparative | 100 | 600 | 0.09 | 0.28 | 0.24 | 0.44 | 0.63 | 0.0211 | 46 |
| example 1 | | | | | | | | | |
| Example 1 | 100 | 500 | 0.14 | 0.30 | 0.25 | 0.43 | 0.61 | 0.0200 | 62 |
| Example 2 | 80 | 440 | 0.17 | 0.37 | 0.26 | 0.50 | 0.62 | 0.0133 | 66 |
| Example 3 | 50 | 410 | 0.18 | 0.43 | 0.28 | 0.53 | 0.65 | 0.0133 | 72 |

In Examples 1 to 3 and Comparative example 1, in the anode after deposition (before fabricating the battery) and in the anode after the battery was fabricated and the cycle test was performed, the wide scattering peaks were observed in the vicinity of shift position 480 cm⁻¹, in the vicinity of shift position 300 cm⁻¹, and in the vicinity of shift position 400 cm⁻¹, respectively. Thereby, it was found that the anode active material layer was composed of silicon having an amorphous structure (refer to FIG. 1B). FIG. 1B shows the Raman spectrum of the amorphous silicon of the anode active material layer after initial charge and discharge measured in Example 8 described later. In Examples 1 to 3 and Comparative example 1, similar Raman spectrums were obtained. For the obtained Raman spectrums, to obtain more accurate information, as shown by the dotted line in FIG. 1B, after baseline correction was made, fitting was made by using Gauss function and each scattering peak was separated. For the scattering peak in the vicinity of 300 cm⁻¹ (intensity LA) and the scattering peak in the vicinity of 400 cm⁻¹ (intensity LO), fitting was made by fixing the peak wavenumber and the half-width.

As shown in Table 1, in Examples 1 to 3, at least one of the foregoing Condition expression 1 and Condition expression 2; and Condition expression 3 were satisfied. Meanwhile, in Comparative example 1, all Condition expressions 1 to 3 were not satisfied. Therefore, in Examples 1 to 3, higher capacity retention ratios were obtained than in Comparative example 1.

### Examples 4 to 9

In these examples, the lithium ion secondary batteries 10 were fabricated in the same manner as that of Examples 1 to 3, except that the anode active material layer was formed by sputtering method.

As an electrode formation apparatus, an opposed target type DC sputtering apparatus (not shown) was used to form the anode 1. As the anode current collector, a strip-shaped electrolytic copper foil having a thickness of 24 μm and the surface roughness value Rz of 2.5 μm with the roughned both faces was used. As an evaporation material, silicon single crystal was used. The deposition rate was 0.5 nm/s, and the anode active material layer being 5 to 6 μm thick was formed. The DC power was 1 kW, and argon was used as discharge gas. The anode active material layers having various degree of local orderliness were formed by adjusting deposition conditions such as the anode current collector temperature, the input electric power, and the gas pressure. In the opposed target type DC sputtering apparatus, the temperature increase due to deposition is small. Thus, an anode current collector holding assembly was heated by a heater to adjust the temperature of the anode current collector. In these examples, the anode active material layer was oxidized by oxygen remaining in the vacuum chamber or the like to contain about 2 atomic % oxygen.

As shown in the following Table 2, specific temperature conditions in the deposition region where the anode active material was deposited in the anode current collector were 230 deg C. in Example 4, 200 deg C. in Example 5, 160 deg C. in Example 6, 120 deg C. in Example 7, 90 deg C. in Example 8, and 60 deg C. in Example 9.

As Comparative examples 2 to 4 relative to Examples 4 to 9, the lithium ion secondary batteries 10 were formed in the same manner as that of Examples 4 to 9, except that the temperature of the anode current collector in the deposition region was 350 deg C. in Comparative example 2, 300 deg C. in Comparative example 3, and 270 deg C. in Comparative example 4, while the deposition rate was 0.5 nm/s identical with that of Example 1.

For the fabricated secondary batteries of Examples 4 to 9 and Comparative examples 2 to 4, evaluation similar to that of Examples 1 to 3 was performed. The results are shown in Table 2 together with the deposition conditions.

TABLE 2
Deposition method of anode active material layer: sputtering method

| | | | | | | | After | Average | Capacity |
|---|---|---|---|---|---|---|---|---|---|
| | Deposition | Deposition | | | After initial | | 10th | of 9 | retention |
| | rate | temperature | After deposition | | cycle | | cycle | cycles | ratio |
| | nm/s | deg C. | LA/TO | LO/TO | LA/TO | LO/TO | LO/TO | Δ (LO/TO) | % |
| Comparative | 0.5 | 350 | 0.05 | 0.18 | 0.16 | 0.34 | 0.59 | 0.0278 | 43 |
| example 2 | | | | | | | | | |
| Comparative | 0.5 | 300 | 0.06 | 0.22 | 0.19 | 0.37 | 0.60 | 0.0256 | 43 |
| example 3 | | | | | | | | | |
| Comparative | 0.5 | 270 | 0.08 | 0.23 | 0.20 | 0.38 | 0.59 | 0.0233 | 41 |
| example 4 | | | | | | | | | |
| Example 4 | 0.5 | 240 | 0.10 | 0.29 | 0.22 | 0.45 | 0.63 | 0.0200 | 58 |
| Example 5 | 0.5 | 210 | 0.12 | 0.28 | 0.25 | 0.44 | 0.59 | 0.0167 | 57 |
| Example 6 | 0.5 | 160 | 0.15 | 0.33 | 0.26 | 0.46 | 0.61 | 0.0167 | 61 |
| Example 7 | 0.5 | 120 | 0.18 | 0.38 | 0.30 | 0.51 | 0.59 | 0.0089 | 69 |
| Example 8 | 0.5 | 90 | 0.25 | 0.42 | 0.35 | 0.53 | 0.60 | 0.0078 | 68 |
| Example 9 | 0.5 | 60 | 0.27 | 0.45 | 0.38 | 0.55 | 0.61 | 0.0067 | 69 |

In Examples 4 to 9 and Comparative examples 2 to 4, in the anode after deposition (before fabricating the battery) and in the anode after the battery was fabricated and the cycle test was performed, the wide scattering peaks were also observed in the vicinity of shift position 480 cm⁻¹, in the vicinity of shift position 300 cm⁻¹, and in the vicinity of shift position 400 cm⁻¹, respectively. Thereby, it was found that the anode active material layer was made of silicon having an amorphous structure. However, as shown in Table 2, in Examples 4 to 9, at least one of the foregoing Condition expression 1 and the Condition expression 2; and Condition expression 3 were satisfied. Meanwhile, in Comparative examples 2 to 4, all Condition expressions 1 to 3 were not satisfied. Therefore, in Examples 4 to 9, higher capacity retention ratios were obtained than in Comparative examples 2 to 4.

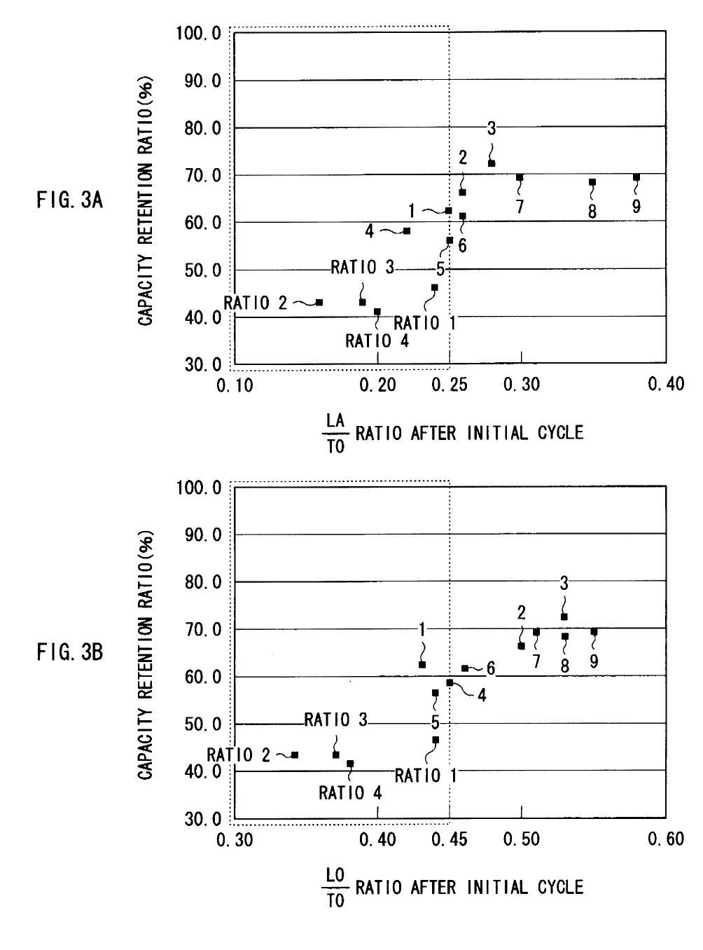

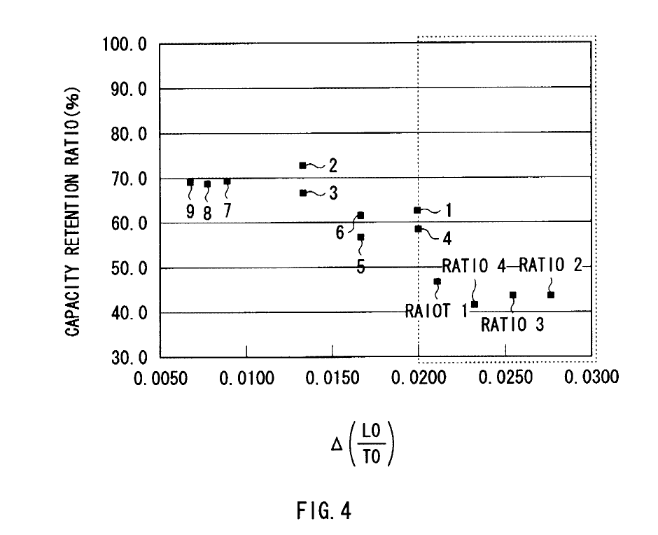

FIGS. 3A and 3B are a graph showing a relation between an LA/TO value after the initial cycle and a capacity retention ratio and a graph showing a relation between an LO/TO value after the initial cycle and a capacity retention ratio in Examples 1 to 9 and Comparative examples 1 to 4. FIG. 4 is a graph showing a relation between an increase Δ(LO/TO) of an LO/TO value per 1 cycle and a capacity retention ratio in Examples 1 to 9 and Comparative examples 1 to 4. The numbers 1 to 9 affixed to data points of the examples in FIGS. 3A, 3B, and 4 are the numbers of the examples. The numbers of ratio 1 to ratio 4 affixed to data points of the comparative examples are the numbers of the comparative examples.

As shown in Table 1, Table 2, and FIGS. 3A and 3B, even if the anode active material layer is composed of amorphous silicon layer as in Comparative example 1 and Comparative examples 2 to 4, in the case that the LA/TO value and the LO/TO value after the initial cycle of the anode active material layer were small and the degree of local orderliness in the amorphous silicon was high, favorable charge and discharge cycle characteristics were not able to be obtained, for example, the capacity retention ratio was low.

Meanwhile, as in Examples 1 to 9, in the case that the LA/TO value after the initial cycle of the anode active material layer was 0.25 or more or the LO/TO value after the initial cycle of the anode active material layer was 0.45 or more and the degree of local orderliness in the amorphous silicon was low, superior charge and discharge cycle characteristics were obtained, for example, the capacity retention ratio was high. In particular, in the case where the LA/TO value after the initial cycle was 0.28 or more or the LO/TO value after the initial cycle was 0.50 or more, the capacity retention ratio was further improved. It might result from the fact that generation of irreversible capacity due to structure change of the active material was prevented. Therefore, as the characteristics of the first anode for secondary battery of the invention, it is necessary that the LA/TO value after the initial charge and discharge cycle was 0.25 or more, or the LO/TO value after the initial charge and discharge cycle was 0.45 or more. In particular, it is more preferable that the LA/TO value after the initial charge and discharge cycle was 0.28 or more, or the LO/TO value after the initial charge and discharge cycle was 0.50 or more.

Further, it was found that to realize the foregoing values, in forming the anode active material layer on the anode current collector, deposition was preferably performed at the deposition temperature of 500 deg C. or less in using vacuum evaporation method, and deposition was preferably performed at the deposition temperature of 230 deg C. or less in using sputtering method.

Further, compared to 0.020<Δ(LO/TO) in Comparative examples 1 to 4, Δ(LO/TO)≦0.020 was established in Examples 1 to 9. Therefore, Δ(LO/TO)≦0.020 is essential as the characteristics of the second anode for secondary battery of the invention.

### Examples 10 to 16

In these examples, the anode active material layers were formed by vacuum evaporation method and the lithium ion secondary batteries 10 were fabricated in the same manner as that of Examples 1 to 3. These examples were different from Examples 1 to 3 in the point that oxygen gas was directly introduced into flow of a silicon evaporation material from the evaporation source to the anode current collector, and thereby the anode active material layers having various oxygen contents were formed. The deposition rate was 50 nm/s constantly. The temperatures of the anode current collectors and the flow rates of the oxygen gas were as follows.

Example 10: temperature of the anode current collector: 380 deg C., flow rate of oxygen gas: 10 sccm

Example 11: temperature of the anode current collector: 330 deg C., flow rate of oxygen gas: 50 sccm

Example 12: temperature of the anode current collector: 280 deg C., flow rate of oxygen gas: 75 sccm

Example 13: temperature of the anode current collector: 250 deg C., flow rate of oxygen gas: 100 sccm

Example 14: temperature of the anode current collector: 230 deg C., flow rate of oxygen gas: 125 sccm

Example 15: temperature of the anode current collector: 210 deg C., flow rate of oxygen gas: 150 sccm

Example 16: temperature of the anode current collector: 200 deg C., flow rate of oxygen gas: 200 sccm

### Example 17

In this example, the lithium ion secondary battery 10 was fabricated by forming the anode active material layer with the use of vacuum evaporation method in the same manner as that of Examples 1 to 3, except for the following points. First, a silicon layer having a thickness about one fifth of the thickness of the anode active material layer to be formed was formed. After that, oxygen gas was sprayed at a flow rate of 50 sccm onto the surface thereof to oxidize the surface. Thereby, a lamination unit composed of the first silicon layer having a smaller oxygen content and the second silicon layer having a larger oxygen content was formed. Such a series of steps was repeated five times, and thereby the anode active material layer in which five layers of the first silicon layers and five layers of the second silicon layers were alternately formed was formed. The deposition rate was 50 nm/s and the anode current collector temperature was 210 deg C.

Table 3 shows the method of forming the anode active material layer in each anode of Examples 3 and 10 to 17, deposition conditions thereof, and oxygen contents (atomic %) contained in the anode active material layer.

TABLE 3
Method of forming anode active material layer:
vacuum evaporation method

| | | Deposition | |
|---|---|---|---|
| | Deposition rate | temperature | Oxygen content ratio |
| | nm/s | Deg C. | Atomic % |
| Example 3 | 50 | 410 | 2.0 |
| Example 10 | 50 | 380 | 3.2 |
| Example 11 | 50 | 330 | 10.5 |
| Example 12 | 50 | 280 | 18.3 |
| Example 13 | 50 | 250 | 25.1 |
| Example 14 | 50 | 230 | 35.4 |
| Example 15 | 50 | 210 | 44.8 |
| Example 16 | 50 | 200 | 47.2 |
| Example 17 | 50 | 210 | Five-layer lamination |

for the fabricated secondary batteries of Examples 10 to 17, evaluation similar to that of Examples 1 to 3 was also performed. The results are shown in Table 4 together with the result of Example 3.

TABLE 4
Deposition method of anode active material layer: vacuum evaporation
method

| | | | | | | | After | Average | Capacity |
|---|---|---|---|---|---|---|---|---|---|
| | Deposition | Deposition | After | | After initial | | 10th | of 9 | retention |
| | rate | temperature | deposition | | cycle | | cycle | cycles | ratio |
| | nm/s | deg C. | LA/TO | LO/TO | LA/TO | LO/TO | LO/TO | Δ (LO/TO) | % |
| Example 3 | 50 | 410 | 0.18 | 0.43 | 0.28 | 0.53 | 0.65 | 0.0133 | 72 |
| Example 10 | 50 | 380 | 0.16 | 0.41 | 0.28 | 0.54 | 0.63 | 0.0100 | 75 |
| Example 11 | 50 | 330 | 0.16 | 0.42 | 0.29 | 0.55 | 0.61 | 0.0067 | 79 |
| Example 12 | 50 | 280 | 0.18 | 0.40 | 0.29 | 0.52 | 0.62 | 0.0111 | 80 |
| Example 13 | 50 | 250 | 0.20 | 0.40 | 0.32 | 0.53 | 0.63 | 0.0111 | 76 |
| Example 14 | 50 | 230 | 0.22 | 0.38 | 0.31 | 0.51 | 0.62 | 0.0122 | 78 |
| Example 15 | 50 | 210 | 0.24 | 0.41 | 0.33 | 0.53 | 0.64 | 0.0122 | 76 |
| Example 16 | 50 | 200 | 0.27 | 0.42 | 0.36 | 0.55 | 0.67 | 0.0133 | 74 |
| Example 17 | 50 | 210 | 0.21 | 0.42 | 0.30 | 0.53 | 0.63 | 0.0111 | 85 |

In Examples 10 to 17, in the anode after deposition (before fabricating the battery) and in the anode after the battery was fabricated and the cycle test was performed, the wide scattering peaks were also observed in the vicinity of shift position 480 cm⁻¹, in the vicinity of shift position 300 cm⁻¹, and in the vicinity of shift position 400 cm⁻¹, respectively. Thereby, it was found that the anode active material layer was composed of silicon having an amorphous structure. Further, as shown in Table 4, in Examples 10 to 17, at least one of the foregoing Condition expression 1 and Condition expression 2; and Condition expression 3 were satisfied. Therefore, in Examples 10 to 17, high capacity retention ratios were obtained.

More specifically, in Examples 10 to 16 in which the oxygen content ratio in the anode active material layer was changed, the increase Δ(LO/TO) of the LO/TO value due to charge and discharge cycle was small where the oxygen content ratio was in the range from 3 to 45 atomic %, and the capacity retention ratio was improved accordingly. Therefore, the oxygen content ratio in the anode active material layer is preferably in the range from 3 to 45 atomic %. Meanwhile, the oxygen content in the anode active material layer in Examples 1 to 9 was about 2 atomic %, and is under 3 atomic %. The oxygen content ratio in the anode active material layer was measured by an energy dispersive X-ray fluorescence spectrometer (EDX). Further, it is also useful that the oxygen content ratio is analyzed by using X-ray photoelectron spectroscopy (XPS) or auger electron spectroscopy (AES).

Further, in Example 17, the first active material layer (first silicon layer) and the second active material layer (second silicon layer) that had the oxygen content ratio different from each other were alternately formed to form the laminated structure. Thereby, the capacity retention ratio was further improved.

### Examples 18 to 20

In Example 18, the anode active material layer was formed by setting the temperature of the anode current collector to 420 deg C., co-evaporating silicon and iron (Fe) with the use of an evaporation source for evaporating silicon and an evaporation source for evaporating iron concurrently. In Example 19, the anode active material layer was formed by setting the temperature of the anode current collector to 420 deg C., co-evaporating silicon and cobalt (Co) with the use of an evaporation source for evaporating silicon and an evaporation source for evaporating cobalt concurrently. In Example 20, the anode active material layer was formed by setting the temperature of the anode current collector to 430 deg C., co-evaporating silicon and titanium (Ti) with the use of an evaporation source for evaporating silicon and an evaporation source for evaporating titanium concurrently. In Examples 18 to 20, the anode was formed and the lithium ion secondary battery 10 was fabricated in the same manner as that of Examples 1 to 3 except for the foregoing point.

Table 5 shows the method of forming the anode active material layer in each anode of Examples 18 to 20, deposition conditions thereof, and elements other than silicon contained in the anode active material layer and contents thereof (atomic %).

TABLE 5
Method of forming anode active material layer:
vacuum evaporation method

| | | | Other element | |
|---|---|---|---|---|
| | Deposition | Deposition | | Content |
| | rate | temperature | | ratio |
| | nm/s | Deg C. | Type | (atomic %) |
| Example 18 | 50 | 420 | Fe | 2.5 |
| Example 19 | 50 | 420 | Co | 3.2 |
| Example 20 | 50 | 430 | Ti | 2.0 |

For the fabricated secondary batteries of Examples 18 to 20, evaluation similar to that of Examples 1 to 3 was also performed. The results are shown in Table 6.

TABLE 6
Deposition method of anode active material layer: vacuum evaporation
method

| | | | | | | | After | Average | Capacity |
|---|---|---|---|---|---|---|---|---|---|
| | Deposition | Deposition | | | After initial | | 10th | of 9 | retention |
| | rate | temperature | After deposition | | cycle | | cycle | cycles | ratio |
| | nm/s | deg C. | LA/TO | LO/TO | LA/TO | LO/TO | LO/TO | Δ (LO/TO) | % |
| Example 18 | 50 | 420 | 0.17 | 0.41 | 0.29 | 0.53 | 0.63 | 0.0111 | 75 |
| Example 19 | 50 | 420 | 0.18 | 0.41 | 0.29 | 0.54 | 0.63 | 0.0100 | 76 |
| Example 20 | 50 | 430 | 0.16 | 0.38 | 0.28 | 0.51 | 0.62 | 0.0122 | 82 |

In Examples 18 to 20, in the anode after deposition (before fabricating the battery) and in the anode after the battery was fabricated and the cycle test was performed, the scattering peaks were also widely observed in the vicinity of shift position 480 cm⁻¹, in the vicinity of shift position 300 cm⁻¹, and in the vicinity of shift position 400 cm⁻¹, respectively. Thereby, it was found that the anode active material layer was composed of silicon having an amorphous structure. Further, as shown in Table 6, in Examples 18 to 20, at least one of the foregoing Condition expression 1 and Condition expression 2; and Condition expression 3 were satisfied. Therefore, in Examples 18 to 20, high capacity retention ratios were obtained. If iron (Fe), cobalt (Co), or titanium (Ti) was contained in the anode active material layer, the capacity retention ratio was further improved.

From the results of Examples 1 to 20 (Tables 1, 2, 4, and 6), it was found that in the anode having the large LA/TO value and the large LO/TO value after deposition, the LA/TO value and the LO/TO value after the initial cycle were also large, and there was a close correlation therebetween.

In Examples 21 to 27, the same anode for secondary battery was used as that of Example 17, but the electrolytic solution was changed as follows.

### Example 21

The composition of the solvent of the electrolytic solution remained EC:DEC=30:70. As electrolyte salts, LiPF₆ at a concentration of 0.9 mol/dm³ and LiBF₄ at a concentration of 0.1 mol/dm³ were dissolved (the composition of the electrolyte salts was identical with that of the following Examples 22 to 27).

### Example 22

As a solvent of the electrolytic solution, vinylene carbonate (VC) was added, and a mixed solvent in which EC, DEC, and VC were mixed at a weight ratio of EC:DEC:VC=30:60:10 was used.

### Example 23

As a solvent of the electrolytic solution, vinylethylene carbonate (VEC) was added, and a mixed solvent in which EC, DEC, and VEC were mixed at a weight ratio of EC:DEC:VEC=30:60:10 was used.

### Example 24

As a solvent of the electrolytic solution, fluoroethylene carbonate (FEC) was added instead of EC, and a mixed solvent in which FEC and DEC were mixed at a weight ratio of FEC:DEC=30:70 was used.

### Example 25

As a solvent of the electrolytic solution, difluoroethylene carbonate (DFEC) was added, and a mixed solvent in which EC, DEC, and DFEC were mixed at a weight ratio of EC:DEC:DFEC=30:60:5 was used.

### Example 26

As a solvent of the electrolytic solution, 1,3-propenesultone (PRS) was added, and a mixed solvent in which EC, DEC, VC, and PRS were mixed at a weight ratio of EC:DEC:VC:PRS=30:59:10:1 was used.

### Example 27

As a solvent of the electrolytic solution, PRS was added, and a mixed solvent in which EC, DEC, DFEC, and PRS were mixed at a weight ratio of EC:DEC:DFEC:PRS=30:64:5:1 was used.

For the fabricated secondary batteries of Examples 21 to 27, evaluation similar to that of Examples 1 to 3 and the like was also performed. The results are shown in Table 7.

TABLE 7
Deposition method of anode active material layer: vacuum evaporation
method

| | | | After | Average | Capacity | | |
|---|---|---|---|---|---|---|---|
| | After initial | | 10th | of 9 | retention | | |
| | cycle | | cycle | cycles | ratio | Electrolyte | |
| | LA/TO | LO/TO | LO/TO | Δ (LO/TO) | % | Solvent | Electrolyte salt |
| Example 17 | 0.30 | 0.53 | 0.63 | 0.0111 | 85 | EC:DEC = 30:70 | Only LiPF₆ |
| Example 21 | 0.28 | 0.54 | 0.63 | 0.0100 | 87 | EC:DEC = 30:70 | LiPF₆ and |
| Example 22 | 0.29 | 0.55 | 0.62 | 0.0078 | 93 | EC:DEC:VC = 30:60:10 | LiBF₄ |
| Example 23 | 0.28 | 0.53 | 0.61 | 0.0089 | 93 | EC:DEC:VEC = 30:60:10 | |
| Example 24 | 0.31 | 0.57 | 0.64 | 0.0078 | 95 | FEC:DEC = 30:70 | |
| Example 25 | 0.30 | 0.56 | 0.62 | 0.0067 | 94 | EC:DEC:DFEC = 30:65:5 | |
| Example 26 | 0.30 | 0.55 | 0.60 | 0.0056 | 94 | EC:DEC:VEC:PRS = 30:59:10:1 | |
| Example 27 | 0.32 | 0.56 | 0.61 | 0.0056 | 96 | EC:DEC:DFEC:PRS = 30:64:5:1 | |

As shown in Table 7, the capacity retention ratio was improved more than that of Example 17 using the same anode for secondary battery by adding LiBF₄ as the electrolyte salt in Example 21, by adding or exchanging vinylene carbonate (VC), vinylethylene carbonate (VEC), fluoroethylene carbonate (FEC), and difluoroethylene carbonate (DFEC) as the solvent of the electrolytic solution in Examples 22 to 25, and adding 1,3-propenesultone (PRS) to the electrolytic solution in Examples 26 and 27. In these examples, the increase Δ(LO/TO) of the LO/TO value due to charge and discharge cycle was kept smaller than that of Example 17, and the capacity retention ratio was improved accordingly. From the results of these examples, it turned out that the structural change of the anode active material layer was prevented by appropriately selecting the electrolyte salt and the solvent composing the electrolyte and thereby the charge and discharge cycle characteristics were improved; and in this case measuring the local disorderliness measurement by Raman spectroscopic analysis was effective.

### Examples 28 to 37

In these examples, the lithium ion secondary battery 10 was fabricated by forming the anode active material layer with the use of vacuum evaporation method in the same manner as that of Examples 1 to 3. However, a given amount of argon gas was introduced from the gas introduction nozzles 15A and 15B. While the anode active material layer was formed, the pressure of the atmosphere covering the surface of the anode current collector in the evaporation region was retained in the range from 1×10⁻² Pa to 5×10⁻¹ Pa.

As Comparative example 5 relative to Examples 28 to 37, the lithium ion secondary battery 10 was fabricated in the same manner as that of Example 1, except that the deposition rate was 200 nm/s and the temperature of the anode current collector in the deposition region was over 600 deg C.

Table 8 shows the method of forming the anode active material layer in each anode of Examples 28 to 37 and Comparative example 5 and deposition conditions thereof, together with the data of Example 1 and Comparative example 1.

TABLE 8
Method of forming anode active material layer:
vacuum evaporation method

| | | | Argon gas | |
|---|---|---|---|---|
| | | Deposition | introduction | Atmosphere |
| | Deposition rate | temperature | amount | pressure |
| | nm/s | Deg C. | sccm | Pa |
| Example 1 | 100 | 500 | — | 0.5 × 10⁻² |
| Example 2 | 80 | 440 | — | 0.5 × 10⁻² |
| Example 28 | 100 | 430 | 30 | 6 × 10⁻² |
| Example 29 | 150 | 530 | 30 | 6 × 10⁻² |
| Example 30 | 200 | >600 | 3 | 0.7 × 10⁻² |
| Example 31 | 200 | >600 | 5 | 1 × 10⁻² |
| Example 32 | 200 | >600 | 10 | 2 × 10⁻² |
| Example 33 | 200 | >600 | 30 | 6 × 10⁻² |
| Example 34 | 200 | 600 | 50 | 10 × 10⁻² |
| Example 35 | 200 | 550 | 70 | 15 × 10⁻² |
| Example 36 | 200 | 500 | 100 | 30 × 10⁻² |
| Example 37 | 200 | 460 | 150 | 50 × 10⁻² |
| Comparative | 100 | 600 | — | 3 × 10⁻² |
| example 1 | | | | |
| Comparative | 200 | >600 | — | 3 × 10⁻² |
| example 5 | | | | |

For the fabricated secondary batteries of Examples 28 to 37 and Comparative example 5, evaluation similar to that of Examples 1 to 3 and the like was also performed. The results are shown in Table 9 together with the result of Example 3.

TABLE 9
Deposition method of anode active material layer: vacuum evaporation
method

| | | | | | | | After | Average | Capacity |
|---|---|---|---|---|---|---|---|---|---|
| | Deposition | Deposition | | | After initial | | 10th | of 9 | retention |
| | rate | temperature | After deposition | | cycle | | cycle | cycles | ratio |
| | nm/s | deg C. | LA/TO | LO/TO | LA/TO | LO/TO | LO/TO | Δ (LO/TO) | % |
| Example 1 | 100 | 500 | 0.14 | 0.30 | 0.25 | 0.43 | 0.61 | 0.0200 | 62 |
| Example 2 | 80 | 440 | 0.17 | 0.37 | 0.26 | 0.50 | 0.62 | 0.0133 | 66 |
| Example 28 | 100 | 430 | 0.20 | 0.45 | 0.30 | 0.55 | 0.62 | 0.0078 | 74 |
| Example 29 | 150 | 530 | 0.18 | 0.44 | 0.29 | 0.52 | 0.61 | 0.0100 | 72 |
| Example 30 | 200 | >600 | 0.11 | 0.30 | 0.25 | 0.43 | 0.61 | 0.0200 | 63 |
| Example 31 | 200 | >600 | 0.13 | 0.35 | 0.27 | 0.49 | 0.62 | 0.0144 | 64 |
| Example 32 | 200 | >600 | 0.17 | 0.38 | 0.28 | 0.51 | 0.63 | 0.0133 | 69 |
| Example 33 | 200 | >600 | 0.17 | 0.41 | 0.28 | 0.52 | 0.63 | 0.0122 | 71 |
| Example 34 | 200 | 600 | 0.18 | 0.45 | 0.30 | 0.51 | 0.61 | 0.0111 | 71 |
| Example 35 | 200 | 550 | 0.20 | 0.47 | 0.31 | 0.52 | 0.63 | 0.0122 | 69 |
| Example 36 | 200 | 500 | 0.19 | 0.48 | 0.32 | 0.54 | 0.61 | 0.0078 | 64 |
| Example 37 | 200 | 460 | 0.19 | 0.50 | 0.31 | 0.56 | 0.61 | 0.0056 | 62 |
| Comparative | 100 | 600 | 0.09 | 0.28 | 0.24 | 0.44 | 0.63 | 0.0211 | 46 |
| example 1 | | | | | | | | | |
| Comparative | 200 | >600 | 0.04 | 0.18 | 0.21 | 0.39 | 0.60 | 0.0233 | 48 |
| example 5 | | | | | | | | | |

As shown in Table 8 and Table 9, in Examples 28 to 37, the capacity retention ratio higher than that of Comparative examples 1 and 5 was obtained. It possibly resulted from the following reason. In these examples, the inert gas was introduced, the pressure of the atmosphere covering the surface of the anode current collector in the evaporation region (deposition region) was retained higher than that of the region surrounding such an evaporation region, and the silicon particles that come by air from the evaporation sources 13A and 13B were moderately scattered. Thereby, silicon having a given amorphous structure was formed not depending on the deposition temperature. In particular, in Examples 28, 29, and 32 to 35, higher capacity retention ratios were obtained by the following reason. The amorphous structure in which the peak intensity ratios LA/TO and LO/TO of the Raman spectrum after the initial charge and discharge respectively satisfied Condition expressions 4 and 5 was formed by keeping the pressure of the atmosphere covering the surface of the anode current collector in the evaporation region in the range from 2×10⁻² Pa to 1.5×10⁻¹ Pa (15×10⁻² Pa). As above, it was confirmed that even if the deposition temperature became high such as over 500 deg C. by increasing the deposition rate, the anode active material layer having a given amorphous structure was formed by using the method such as adjusting the pressure of the atmosphere by introducing the inert gas, and the capacity retention ratio was improved.

The invention has been described with reference to the embodiment and the examples. However, the invention is not limited to the foregoing embodiment and the foregoing examples, and various modifications may be made.

For example, in the foregoing embodiment and the foregoing examples, the description has been given of the battery using the square can as a package member. However, the invention is applicable to a battery having any other shape such as a coin type battery, a cylindrical battery, a button type battery, a thin battery, and a large battery in addition to the square battery. Further, the invention is also applicable to a battery using a film package member or the like as a package member. Furthermore, the invention is also applicable to a lamination type battery in which a plurality of anodes and a plurality of cathodes are layered.

Further, in the foregoing embodiment and the foregoing examples, in forming the anode active material layer on the anode current collector, the pressure of the atmosphere covering the surface of the anode current collector in the evaporation region was adjusted by introducing argon gas. However, another gas may be used.

According to the secondary battery of the invention, the silicon simple substance and the like are used as the anode active material. Thereby, a high energy capacity and favorable charge and discharge cycle characteristics are realized. In addition, the secondary battery of the invention contributes to realizing a small, light-weight, and thin mobile electronic device and improving its convenience.

It should be understood by those skilled in the art that various modifications, combinations, sub-combinations and alternations may occur depending on design requirements and other factors insofar as they are within the scope of the appended claims or the equivalents thereof.

What is claimed is:

1. An anode for secondary battery provided with an anode active material layer containing silicon on an anode current collector, wherein
silicon in the anode active material layer has an amorphous structure, and
in a Raman spectrum of silicon having the amorphous structure after an initial charge and discharge, 0.25≦LA/TO and/or 0.45≦LO/TO is satisfied, where an intensity of a scattering peak occurred in the vicinity of shift position 480 cm⁻¹ based on scattering due to transverse optical phonon is TO, an intensity of a scattering peak occurred in the vicinity of shift position 300 cm⁻¹ based on scattering due to longitudinal acoustic phonon is LA, and an intensity of a scattering peak occurred in the vicinity of shift position 400 cm⁻¹ based on scattering due to longitudinal optical phonon is LO.

2. The anode for secondary battery according to claim 1, wherein 0.28≦LA/TO and/or 0.50≦LO/TO is satisfied.

3. An anode for secondary battery provided with an anode active material layer containing silicon on an anode current collector, wherein
silicon in the anode active material layer has an amorphous structure, and
in a Raman spectrum of silicon having the amorphous structure after an initial charge and discharge, Δ(LO/TO) as an increase of a ratio of LO to TO (LO/TO) due to 1 cycle of charge and discharge is expressed as Δ(LO/TO)≦0.020, where an intensity of a scattering peak occurred in the vicinity of shift position 480 cm⁻¹ based on scattering due to transverse optical phonon is TO, and an intensity of a scattering peak occurred in the vicinity of shift position 400 cm⁻¹ based on scattering due to longitudinal optical phonon is LO.

4. The anode for secondary battery according to claim 1 or claim 3, wherein the anode current collector and the anode active material layer are alloyed in at least part of an interface therebetween.

5. The s anode for secondary battery according to claim 1 or claim 3, wherein the anode active material layer is formed by vapor-phase deposition method and/or firing method.

6. The anode for secondary battery according to claim 1 or claim 3, wherein the anode active material layer contains 3 to 45 atomic % oxygen as an element.

7. The anode for secondary battery according to claim 1 or claim 3, wherein as the anode active material layer, a plurality of first active material layers that do not contain oxygen or have a small oxygen content and a plurality of second active material layers that have a large oxygen content are alternately provided.

8. The anode for secondary battery according to claim 1 or claim 3, wherein as the anode current collector, a material containing copper is used.

9. The anode for secondary battery according to claim 1 or claim 3, wherein a face of the anode current collector on which the anode active material layer is roughned.

10. The anode for secondary battery according to claim 1 or claim 3, wherein the anode active material layer contains a metal element different from a component composing the current collector as an element.

11. A secondary battery comprising:
a cathode;
an electrolyte; and
the anode for secondary battery according to claim 1.

12. The secondary battery according to claim 11, wherein a cathode active material composing the cathode contains a lithium compound.

13. The secondary battery according to claim 11, wherein a cyclic ester carbonate having an unsaturated bond is contained as a solvent composing the electrolyte.

14. The secondary battery according to claim 13, wherein the cyclic ester carbonate having an unsaturated bond is vinylene carbonate or vinylethylene carbonate.

15. The secondary battery according to claim 11, wherein a fluorine-containing compound obtained by substituting part or all of hydrogen atoms of a cyclic ester carbonate and/or a chain ester carbonate is substituted with a fluorine atom is contained as a solvent composing the electrolyte.

16. The secondary battery according to claim 15, wherein the fluorine-containing compound is difluoroethylene carbonate.

17. The secondary battery according to claim 11, wherein the electrolyte contains a sultone compound or a sulfone compound.

18. The secondary battery according to claim 17, wherein the sultone compound is 1,3-propenesultone.

19. The secondary battery according to claim 11, wherein a lithium compound containing boron and fluorine as an element is contained as an electrolyte salt composing the electrolyte.

20. A method of manufacturing an anode for secondary battery comprising the steps of:
preparing an anode current collector; and then
forming an anode active material layer containing silicon on the anode current collector by vacuum evaporation method in which deposition is performed at a deposition temperature of 500 deg C. or less or sputtering method in which deposition is performed at a deposition temperature of 230 deg C. or less.

21. The method of manufacturing the anode for secondary battery according to claim 20, wherein the anode active material layer is formed on the anode current collector by the vacuum evaporation method in which deposition is performed at a deposition temperature of 200 deg C. or more.

22. A method of manufacturing the anode for secondary battery, wherein after an anode current collector is prepared, an anode active material layer containing silicon is formed on the anode current collector by sputtering method while a surface of the anode current collector is covered with an atmosphere having a pressure in the range from 1×10⁻² Pa to 5×10⁻¹ Pa.

23. The method of manufacturing the anode for secondary battery according to claim 22, wherein the anode active material layer is formed while the surface of the anode current collector is covered with an atmosphere having a pressure in the range from 2×10⁻² Pa to 1.5×10⁻¹ Pa.
